(19) United States
(12) Patent Application Publication
(10) Pub. No.: US 2015/0379553 A1
(43) Pub. Date: Dec. 31, 2015

(54) APPARATUS AND METHOD FOR MOBILE-DISPATCHER FOR OFFER REDEMPTION WORK FLOWS

(71) Applicant: RetailMeNot, Inc., Austin, TX (US)

(72) Inventor: Christopher Kent Copeland, Austin, TX (US)

(21) Appl. No.: 14/749,855

(22) Filed: Jun. 25, 2015

Related U.S. Application Data
(60) Provisional application No. 62/016,655, filed on Jun. 25, 2014.
(60) Provisional application No. 62/041,328, filed on Aug. 25, 2014.

(51) Int. Cl. G06Q 30/02

(52) U.S. Cl. CPC G06Q 30/0239

(57) ABSTRACT

Provided is a of dynamically adjusting an online coupon, or other offer, redemption work flow presented to a consumer to mitigate effects from more limited user-interface constraints of mobile computing devices, the process including: obtaining a plurality of mobile-suitability values; receiving from a remote mobile computing device of a user, a request for offer content; ascertaining a selected merchant website at which the offer is redeemable; retrieving a selected mobile-suitability value for the selected merchant website; obtaining, from the mobile computing device, data indicative of user-interface constraints of the mobile computing device; determining to send instructions to present content on the mobile computing device, the determination being based on the user-interface constraints of the mobile computing device and the selected mobile-suitability value for the selected merchant website, and the content being suitable for the mobile computing device; and sending the instructions to present the content.

### CROSS-REFERENCE TO RELATED APPLICATIONS

The present application claims the benefit of U.S. Provisional Patent Application 62/016,655 filed 25 Jun. 2014 and U.S. Provisional Patent Application 62/041,328 filed 25 Aug. 2014. Each parent patent application is incorporated by reference in its entirety for all purposes.

### BACKGROUND

1. Field

The present invention relates generally to online coupons and other offers and, more specifically, to a mobile-dispatcher for offer redemption work flows.

2. Description of the Related Art

Offer-discovery systems provide a service by which merchants inform customers of offers, for example, deals (e.g., discounts, favorable shipping terms, or rebates) or coupons (e.g., printable coupons for in-store use or coupon codes for use online). Typically, these systems store information about offers from a relatively large number of merchants and provide an interface by which customers can identify offers in which the customer is likely to be interested. Merchants have found the offer-discovery systems to be a relatively effective form of marketing, as cost-sensitive consumers are drawn to such systems due to their relatively comprehensive listings of offers, and as a result, the number of offers listed on such systems has increased in recent years.

Recently, consumers have begun searching and viewing offers using mobile computing devices, like cell phones and tablet computers and, more recently, wearable mobile computing devices, like smart watches and head-mounted displays. Frequently, however, merchants design their websites for full-sized computers, like desktop computers, laptop computers, and larger tablet computers, e.g., those devices with a display larger than eight-inches measured diagonally. As a result, consumers who view offers on mobile devices generally redeem those offers at a lower rate than consumers viewing the same offers on full-sized computers. This effect is believed to cause consumers to miss-out on valuable offers, merchants to miss out on potential revenue because of lost conversions, and publishers to miss out on revenue because of lost attributions or conversions.

### SUMMARY

The following is a non-exhaustive listing of some aspects of the present techniques. These and other aspects are described in the following disclosure.

Some aspects include a process of dynamically adjusting an online coupon, or other offer, redemption work flow presented to a consumer to mitigate effects from more limited user-interface constraints of mobile computing devices relative to desktop computing devices, the process including: obtaining for a plurality of merchant websites a plurality of mobile-suitability values, each mobile-suitability value being indicative of suitability of a respective one of the plurality of merchant websites for use on mobile computing devices; receiving, over a network, from a remote mobile computing device of a user, a request for offer content that causes the mobile computing device to display an offer; ascertaining a selected merchant website, among the plurality of merchant websites, at which the offer is redeemable; retrieving, from the plurality of mobile-suitability values, a selected mobile-suitability value for the selected merchant website; obtaining, from the mobile computing device, data indicative of user-interface constraints of the mobile computing device; determining to send instructions to present content on the mobile computing device, the determination being based on the user-interface constraints of the mobile computing device and the selected mobile-suitability value for the selected merchant website, and the content being suitable for the mobile computing device; and sending the instructions to present the content to the mobile computing device.

Some aspects include a process of inferring a user's intent when searching for coupons and other offers, the process including: obtaining a purchase-intent model, the purchase-intent model being configured to calculate a purchase-intent score based on a geolocation of a user, a time during which the user requests offer content, a product category for which the user requests offer content, or a search history of the user requesting offer content, wherein the purchase-intent score estimates the likelihood that a user is shopping with intent to purchase rather than with intent to browse; receiving, via a network, a request for offer content from a computing device of a user; calculating, with one or more processors, a purchase-intent score with the purchase-intent model based on the request for offer content; determining that the purchase-intent score satisfies a threshold; selecting offer content based on the determination that the purchase-intent score satisfies the threshold; and sending the offer content to the computing device of the user.

Some aspects include a tangible, non-transitory, machine-readable medium storing instructions that when executed by a data processing apparatus cause the data processing apparatus to perform operations including the above-mentioned processes.

Some aspects include a system, including: one or more processors; and memory storing instructions that when executed by the processors cause the processors to effectuate operations of the above-mentioned processes.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of an offer-discovery system having a mobile dispatcher in accordance with some of the present techniques;

FIG. 2 shows an example of a process for dispatching offer-redemption work flows on mobile devices;

FIG. 3 shows another example of a process for dispatching offer-redemption work flows on mobile and non-mobile devices;

FIG. 4 shows an example of an affiliate-network system having a mobile dispatcher in accordance with some of the present techniques; and

FIG. 5 shows an example of a computer system by which the present techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the affiliate networking field. Indeed, applicants wish to emphasize the difficulty of recognizing those problems that are nascent and will become much more apparent in the future should trends in the industry continue as applicants expect. Further, because multiple problems are addressed, it should be understood that some embodiments are problem-specific, and not all embodiments address every problem with traditional systems described herein or provide every benefit described herein. That said, improvements that solve various permutations of these problems are described below.

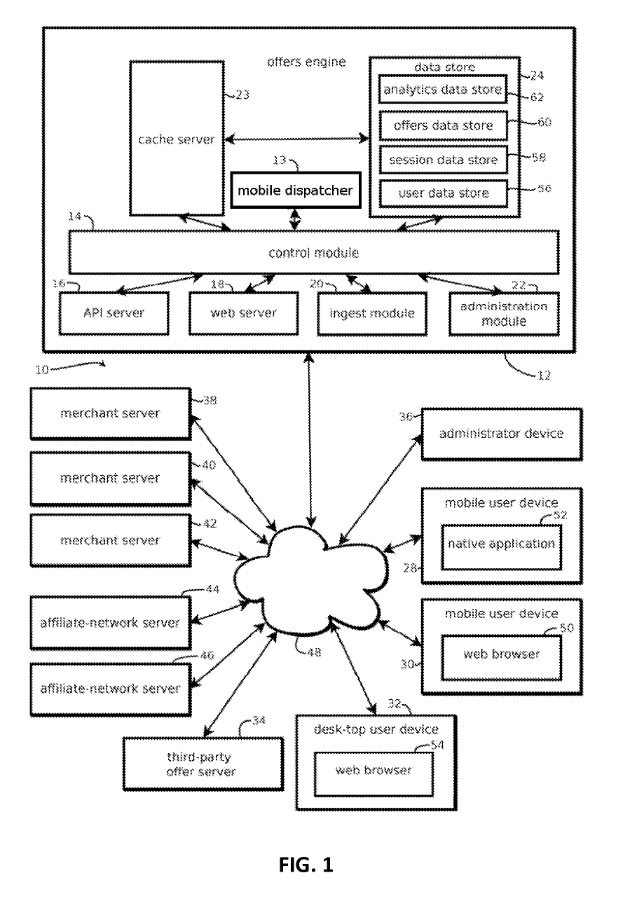

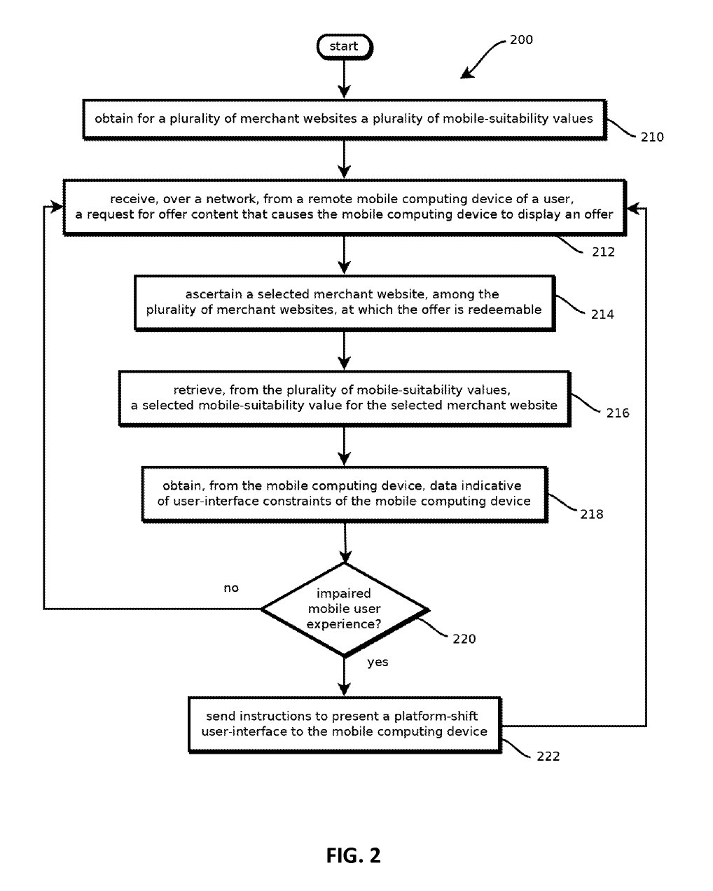

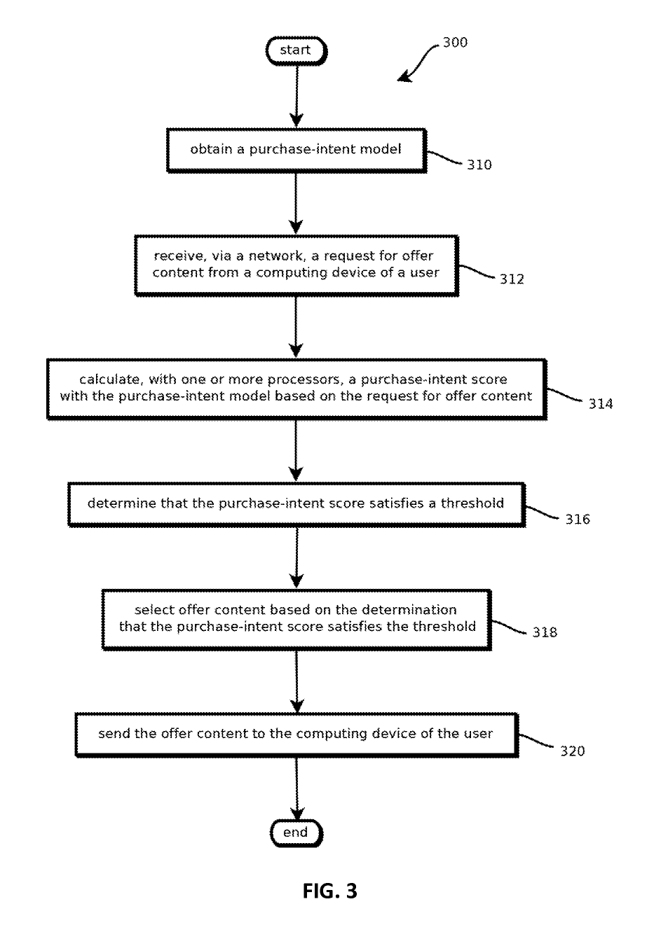

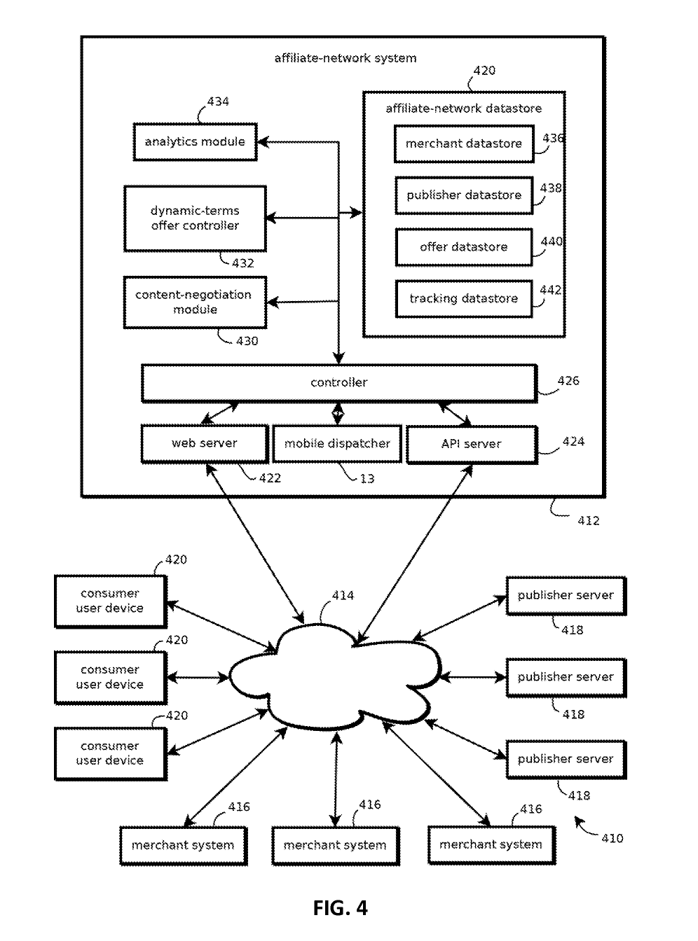

FIG. 1 shows an embodiment of an offer-discovery system 10 that, in some embodiments, includes a mobile dispatcher module 13 to mitigate some of the above-mentioned issues with traditional systems. The mobile dispatcher 13 may determine the optimal (or an improved) work flow (e.g., sequence of user interfaces) to present to a mobile web visitor based on the merchant the user is viewing and other factors, such that conversions (e.g., offer redemptions or orders placed with merchants) are increased relative to conventional systems. Embodiments may further infer whether the user is viewing offers with the intent to purchase or browse and select content for display based on the determination. The mobile dispatcher 13 may interface with the following aspects of the offer-discovery system 10, or reside within an affiliate networking system described below with reference to FIG. 4. In operation, the dispatcher 13 may perform processes described below with reference to FIGS. 2 and 3.

The exemplary system 10 includes an offers engine 12 that, in some embodiments, is capable of reducing the burden on users attempting to identify offers relevant to them from among a relatively large pool of offers (e.g., more than 100, more than 1,000, or more than 10,000). To this end and others, the offers engine 12 maintains device-independent user profiles (or portions of user profiles) by which offers interfaces may be relatively consistently configured across multiple user devices with which the user interacts with the offers engine 12. Further, the offers engine 12, in some embodiments, includes a number of features expected to facilitate relatively quick identification of relevant offers by a user, features that include cached storage of data related to likely relevant offers, faceted presentation of offers by which users can select among offers within various categories, and a number of other techniques described below for assisting with offer identification. The offers engine 12 is also expected to facilitate relatively low operating costs by, in some embodiments, automating parts of the process by which offer related data is acquired from sources, such as affiliate networks merchants, administrators, or users, and automating parts of the process by which transaction data indicative of acceptance, settlement, or clearing of offers is obtained and processed.

In the illustrated embodiment, the offers engine 12 includes the mobile-dispatcher 13, a control module 14, an application program interface (API) server 16, a web server 18, an ingest module 20, an administration module 22, a data store 24, and a cache server 23. These components, in some embodiments, communicate with one another in order to provide the functionality of the offers engine 12 described herein. As described in greater detail below, in some embodiments, the data store 24 may store data about offers and users' interactions with those offers; the cache server 23 may expedite access to this data by storing likely relevant data in relatively high-speed memory, for example, in random-access memory or a solid-state drive; the web server 20 may serve webpages having offers interfaces by which users discover relevant offers; the API server 16 may serve data to various applications that process data related to offers; the ingest module 20 may facilitate the intake of data related to offers from affiliate networks, users, administrators, and merchants; and the administration module 22 may facilitate curation of offers presented by the API server 16 and the web server 18. The operation of these components 16, 18, 20, 22, 24, and 23 may be coordinated by the control module 14, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

Among other operations, the offers engine 12 of this embodiment presents offers to users; receives data from users about their interaction with the offers (for example, the user's favorite offers or offer attributes; statistics about the offers the user has identified, accepted, or otherwise provided data about; or the identity of other users with whom the user communicates about offers and the content of those communications; provided that users opt to have such data obtained); customizes the presentation of offers based on this received data; and facilitates the processing of compensation from merchants (either directly or through affiliate networks) as a result of users accepting (or taking a specific action, like clicking or viewing, in some embodiments or use cases) offers. This interaction with users may occur via a website viewed on a desktop computer, tablet, or a laptop of the user. And in some cases, such interaction occurs via a mobile website viewed on a smart phone, tablet, or other mobile user device, or via a special-purpose native application executing on a smart phone, tablet, or other mobile user device. Presenting and facilitating interaction with offers across a variety of devices is expected to make it easier for users to identify and recall relevant offers at the time the user is interested in those offers, which is often different from the time at which the user first discovers the offers. In particular, some embodiments allow users to store data indicative of offers relevant to that user using one device, such as a desktop computer in the user's home, and then view those offers at a later time, such as on a native mobile application when in a retail store.

To illustrate an example of the environment in which the offers engine 12 operates, the illustrated embodiment of FIG. 1 includes a number of components with which the offers engine 12 communicates: mobile user devices 28 and 30; a desk-top user device 32; a third party server 34; an administrator device 36; merchant servers 38, 40, and 42; and affiliate-network servers 44 and 46. Each of these devices communicates with the offers engine 12 via a network 48, such as the Internet or the Internet in combination with various other networks, like local area networks, cellular networks, or personal area networks.

The mobile user devices 28 and 30 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of the mobile user devices 28 and 30 may store instructions that when executed by the associated processor provide an operating system and various applications, including a web browser 50 or a native mobile application 52. The native application 52, in some embodiments, is operative to provide an offers interface that communicates with the offers engine 12 and facilitates user interaction with data from the offers engine 12. Similarly, the web browser 50 may be configured to receive a website from the offers engine 12 having data related to deals and instructions (for example, instructions expressed in JavaScript) that when executed by the browser (which is executed by the processor) cause the mobile user device to communicate with the offers engine 12 and facilitate user interaction with data from the offers engine 12. The native application 52 and the web browser 50, upon rendering a webpage from the offers engine 12, may generally be referred to as client applications of the offers engine 12, which in some embodiments may be referred to as a server. Embodiments, however, are not limited to client/server architectures, and the offers engine 12, as illustrated, may include a variety of components other than those functioning primarily as a server.

The desk-top user device 32 may also include a web browser 54 that serves the same or similar role as the web browser 50 in the mobile user device 30. In addition, the desktop user device 32 may include a monitor; a keyboard; a mouse; memory; a processor; and a tangible, non-transitory, machine-readable memory storing instructions that when executed by the processor provide an operating system and the web browser.

Third-party offer server 34 may be configured to embed data from the offers engine 12 in websites or other services provided by the third-party offer server 34. For example, third-party offer server 34 may be a server of a social networking service upon which users post comments or statistics about offers with which the user has interacted, or the users may use the offer server 34 to recommend offers to others or identify offers to avoid. In another example, third-party offer server 34 may include various services for publishing content to the Web, such as blogs, tweets, likes, dislikes, ratings, and the like. In another example, third-party offer server 34 provides services by which third-parties curate offers hosted by the offers engine 12.

Merchant servers 38, 40, and 42 host websites or other user accessible content interfaces by which users can accept offers hosted by the offers engine 12. In some embodiments, and in some use cases, the merchant servers 38, 40, and 42 host retail websites that present a plurality of items for sale by the merchant, a subset of which may include items to which offers apply, thereby generally making the item for sale more desirable to cost-sensitive consumers than under the terms presented by the merchant in the absence of the offer. For example, the offers may include free or discounted shipping, a discounted price, a bulk discount, a rebate, a referral award, or a coupon, such as a coupon acceptable by presenting a coupon code during checkout on the merchant website, or a printable or displayable coupon (e.g., on the screen of a mobile device) for in-store use, the printable or otherwise displayable coupon having, in some cases, a machine readable code (e.g., a bar code or QR code for display and scanning, or a code passed via near-field communication or Bluetooth™). In some embodiments, the merchant website includes a checkout webpage having an interface for the user to enter payment information and a coupon code, and the merchant website (either with logic on the client side or the server-side) may validate the coupon code entered by the user and, upon determining that the coupon code is valid, adjust the terms presented to the user for acceptance in accordance with the offer. In some cases, merchant's may provide native applications for mobile devices, and offers may link directly to the mobile application, such that when offer is selected on a mobile device by a consumer, the native application of a merchant at which the offer is redeemable launches. In such cases, the native application may send the merchant an identifier of the publisher that linked to the native application, such that the publisher may be compensated.

Some merchants may limit the number of uses of a given coupon, limit the duration over which the coupon is valid, or apply other conditions to use of the coupon, each of which may add to the burden faced by users seeking to find valid coupons applicable to an item the user wishes to purchase. As noted above, some embodiments of the offers engine 12 are expected to mitigate this burden.

Further, in some embodiments, the merchant servers 38, 40, and 42 provide data about offers to the offers engine 12 or (i.e., and/or, as used herein, unless otherwise indicated) data about transactions involving offers. In use cases in which the operator of the offers engine 12 has a direct affiliate-marketing relationship with one of the merchants of the merchant servers 38, 40, or 42, the transaction data may provide the basis for payments by the merchant directly to the operator of the offers engine 12. For example, payments may be based on a percentage of transactions to which offers were applied, a number of sales to which offers were applied, or a number of users who viewed or selected or otherwise interacted with an offer by the merchant.

Affiliate-network servers 44 and 46, in some embodiments and some use cases, are engaged when the entity operating the offers engine 12 does not have a direct affiliate-marketing relationship with the merchant making a given offer. In some cases, the mobile-dispatcher 13 may be disposed in an affiliate-network system including such a server, as described below with reference to FIG. 4. In many affiliate marketing programs, merchants compensate outside entities, such as third-party publishers, for certain activities related to sales by that merchant and spurred by the outside entity. For example, in some affiliate marketing programs, merchants compensate an affiliate, such as the entity operating the offers engine 12, in cases in which it can be shown that the affiliate provided a given coupon code to a given user who then used that coupon code in a transaction with the merchant. Demonstrating this connection to the merchant is one of the functions of the affiliate-networks.

Affiliate-networks are used, in some use cases, because many coupon codes are not affiliate specific and are shared across multiple affiliates, as the merchant often desires the widest distribution of a relatively easily remembered coupon code. Accordingly, in some use cases, the merchant, affiliate network, and affiliate cooperate to use client-side storage to indicate the identity of the affiliate that provided a given coupon code to a user. To this end, in some embodiments, when a webpage offers interface is presented by the offers engine 12 in the web browsers 50 or 54, that webpage is configured by the offers engine 12 to include instructions to engage the affiliate network server 44 or 46 when a user selects an offer, for example, by clicking on, touching, or otherwise registering a selection of an offer. The website provided by the offers engine 12 responds to such a selection by, in some embodiments, transmitting a request to the appropriate affiliate-network server 44 or 46 (as identified by, for example, an associated uniform resource locator (URL) in the webpage) for a webpage or portion of a webpage (e.g., browser-executable content). The request to the affiliate-network server may include (e.g., as parameters of the URL) an identifier of the affiliate, the offer, and the merchant, and the returned content from the affiliate-network server may include instructions for the web browser 50 or 54 to store in memory (e.g., in a cookie, or other form of browser-accessible memory, such as a SQLite database or in a localStorage object via a localStorage.setItem command) an identifier of the affiliate that provided the offer that was selected.

The webpage from the offers engine 12 (or the content returned by the affiliate network server 44 or 46) may further include browser instructions to navigate to the website served by the merchant server 38, 40, or 42 of the merchant associated with the offer selected by the user, and in some cases to the webpage of the item or service associated with the offer selected by the user. When a user applies the offer, for example by purchasing the item or service or purchasing the item or service with the coupon code, the merchant server 38, 40, or 42 may transmit to the user device upon which the item was purchased browser instructions to request content from the affiliate network server 44 or 46, and this requested content may retrieve from the client-side memory the identifier of the affiliate, such as the operator of the offers engine 12, who provided the information about the offer to the user. The affiliate network may then report to the merchant the identity of the affiliate who should be credited with the transaction, and the merchant may compensate the affiliate (or the affiliate network may bill the merchant, and the affiliate network may compensate the affiliate), such as the operator of the offers engine 12. Thus, the affiliate network in this example acts as an intermediary, potentially avoiding the need for cross-domain access to browser memory on the client device, a feature which is generally not supported by web browsers for security reasons. (Some embodiments may, however, store in client-side browser-accessible memory an identifier of the affiliate upon user selection of the offer, with this value designated as being accessible via the merchant's domain, and provide the value to the merchant upon a merchant request following acceptance of the offer, without passing the identifier through an affiliate network, using a browser plug-in for providing cross-domain access to browser memory or a browser otherwise configured to provide such access.)

A similar mechanism may be used by the native application 52 for obtaining compensation from merchants. In some embodiments, the native application 52 includes or is capable of instantiating a web browser, like the web browser 50, in response to a user selecting an offer presented by the native application 52. The web browser instantiated by the native application 52 may be initialized by submitting the above-mentioned request for content to the affiliate-network server 44 or 46, thereby storing an identifier of the affiliate (i.e., the entity operating the offers engine 12 in this example) in client-side storage (e.g., in a cookie, localStorage object, or a database) of the mobile user device 28, and thereby navigating that browser to the merchant website. In other use cases, the operator of the offers engine 12 has a direct relationship with the merchant issuing the offer, and the selection of an offer within the native application 52 or the desktop or mobile website of the offers engine 12 (generally referred to herein as examples of an offer interface) may cause the user device to request a website from the associated merchant with an identifier of the affiliate included in the request, for example as a parameter of a URL transmitted in a GET request to the merchant server 38, 40, or 42 for the merchant's website.

Administrator device 36 may be a special-purpose application or a web-based application operable to administer operation of the offers engine 12, e.g., during use by employees or agents of the entity operating the offers engine 12. In some embodiments, the administration module 22 may communicate with the administrator device 36 to present an administration interface at the administrator device 36 by which an administrator may configure offers interfaces presented to users by the offers engine 12. In some embodiments, the administrator may enter offers into the offers engine 12; delete offers from the offers engine 12; identify offers for prominent placement within the offers interface (e.g., for initial presentation prior to user interaction); moderate comments on offers; view statistics on offers, merchants, or users; add content to enhance the presentation of offers; or categorize offers.

Thus, the offers engine 12, in some embodiments, operates in the illustrated environment by communicating with a number of different devices and transmitting instructions to various devices to communicate with one another. The number of illustrated merchant servers, affiliate network servers, third-party servers, user devices, and administrator devices is selected for explanatory purposes only, and embodiments are not limited to the specific number of any such devices illustrated by FIG. 1.

The offers engine 12 of some embodiments includes a number of components introduced above that facilitate the discovery of offers by users. For example, the illustrated API server 16 may be configured to communicate data about offers via an offers protocol, such as a representational-state-transfer (REST)-based API protocol over hypertext transfer protocol (HTTP). Examples of services that may be exposed by the API server 18 include requests to modify, add, or retrieve portions or all of user profiles, offers, or comments about offers. API requests may identify which data is to be modified, added, or retrieved by specifying criteria for identifying records, such as queries for retrieving or processing information about particular categories of offers, offers from particular merchants, or data about particular users. In some embodiments, the API server 16 communicates with the native application 52 of the mobile user device 28 or the third-party offer server 34.

The illustrated web server 18 may be configured to receive requests for offers interfaces encoded in a webpage (e.g. a collection of resources to be rendered by the browser and associated plug-ins, including execution of scripts, such as JavaScript™, invoked by the webpage). In some embodiments, the offers interface may include inputs by which the user may request additional data, such as clickable or touchable display regions or display regions for text input. Such inputs may prompt the browser to request additional data from the web server 18 or transmit data to the web server 18, and the web server 18 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 18 may communicate with web browsers, such as the web browser 50 or 54 executed by user devices 30 or 32. In some embodiments, the webpage is modified by the web server 18 based on the type of user device, e.g., with a mobile webpage having fewer and smaller images and a narrower width being presented to the mobile user device 30, and a larger, more content rich webpage being presented to the desk-top user device 32. An identifier of the type of user device, either mobile or non-mobile, for example, may be encoded in the request for the webpage by the web browser (e.g., as a user agent string in an HTTP header associated with a GET request), and the web server 18 may select the appropriate offers interface based on this embedded identifier, thereby providing an offers interface appropriately configured for the specific user device in use.

The illustrated ingest module 20 may be configured to receive data about new offers (e.g., offers that are potentially not presently stored in the data store 24), such as data feeds from the affiliate network servers 44 and 46, identifications of offers from user devices 28, 30, or 32, offers identified by third-party offer server 34, offers identified by merchant servers 38, 40, or 42, or offers entered by an administrator via the administrator device 36. In some embodiments, the ingest module 20 may respond to receipt of a record identifying a potentially new offer by querying the data store 24 to determine whether the offer is presently stored. Upon determining that the offer is not presently stored by the data store 24, the ingest module 20 may transmit a request to the data store 24 to store the record. In some cases, the data about new offers may be an affiliate data-feed from an affiliate network containing a plurality of offer records (e.g., more than 100), each record identifying offer terms, a merchant, a URL of the merchant associated with the offer, a product description, and an offer identifier. The ingest module 22 may periodically query such data-feeds from the affiliate-network servers 44 or 46, parse the data-feeds, and iterate through (or map each entry to one of a plurality of processes operating in parallel) the records in the data-feeds. Bulk, automated processing of such data-feeds is expected to lower operating costs of the offers engine 12.

The administration module 22 may provide an interface by which an administrator operating the administrator device 36 curates and contextualizes offers. For example, the administration module 22 may receive instructions from administrator that identify offers to be presented in the offer interface prior to user interaction with the offer interface, or offers to be presented in this initialized offers interface for certain categories of users, such as users having certain attributes within their user profile. Further, in some embodiments, the administration module 22 may receive data descriptive of offers from the administrator, such as URLs of images relevant to the offer, categorizations of the offer, normalized data about the offer, and the like.

The illustrated data store 24, in some embodiments, stores data about offers and user interactions with those offers. The data store 24 may include various types of data stores, including relational or non-relational databases, document collections, hierarchical key-value pairs, or memory images, for example. In this embodiment, the data store 24 includes a user data store 56, a session data store 58, an offers data store 60, and an analytics data store 62. These data stores 56, 58, 60, and 62 may be stored in a single database, document, or the like, or may be stored in separate data structures.

In this embodiment, the illustrated user data store 56 includes a plurality of records, each record being a user profile and having a user identifier, a list of offers (e.g., identifiers of offers) identified by the user as favorites, a list of categories of offers identified by the user as favorites, a list of merchants identified by the user as favorites, account information for interfacing with other services to which the user subscribes (e.g., a plurality of access records, each record including an identifier of a service, a URL of the service, a user identifier for the service, an OAuth access token credential issued by the service at the user's request, and an expiration time of the credential), a user password for the offers engine 12, a location of the user device or the user (e.g., a zip code of the user), and a gender of the user. In some embodiments, each user profile includes a list of other users identified by the user of the user profile as being people in whose commentary on, or curation of, offers the user is interested, thereby forming an offers-interest graph. In some embodiments, users have control of their data, including what is stored and who can view the data, and can choose to opt-in to the collection and storage of such user data to improve their experience with the offers engine 12.

In this embodiment, the session data store 58 stores a plurality of session records, each record including information about a session a given user is having or has had with the offers engine 12. The session records may specify a session identifier, a user identifier, and state data about the session, including which requests have been received from the user and what data has been transmitted to the user. Session records may also indicate the IP address of the user device, timestamps of exchanges with the user device, and a location of the user device (e.g., retail store or aisle in a retail store in which the user device is located).

The illustrated offers data store 60, in some embodiments, includes a plurality of offer records, each offer record may identify a merchant, offers by that merchant, and attributes of the relationship with the merchant, e.g., whether there is a direct relationship with the merchant by which the merchant directly compensates the operator of the offers engine 12 or whether the merchant compensates the operator of the offers engine 12 via an affiliate network and which affiliate network. The offers by each merchant may be stored in a plurality of merchant-offer records, each merchant-offer record may specify applicable terms and conditions of the offer, e.g., whether the offer is a discount, includes free or discounted shipping, requires purchase of a certain number of items, is a rebate, or is a coupon (which is not to suggest that these designations are mutually exclusive). In records in which the offer is a coupon, the record may further indicate whether the coupon is for in-store use (e.g. whether the coupon is associated with a printable image for presentation at a point-of-sale terminal, a mobile device-displayable image, or other mediums) or whether the coupon is for online use and has a coupon code, in which case the coupon code is also part of the merchant-offer record. The merchant-offer records may also include an expiration date of the offer, comments on the offer, rankings of the offer by users, a time at which the offer was first issued or entered into the offers engine 12, and values (e.g., binary values) indicating whether users found the offer to be effective, with each value or ranking being associated with a timestamp, in some embodiments. The values and rankings may be used to calculate statistics indicative of the desirability of the offer and likely success of accepting the offer. The timestamps associated with the values, rankings, and time of issuance or entry into the offers engine 12 may also be used to weight rankings of the offer, with older values being assigned less weight than newer values and older offers being ranked lower than newer offers, all other things being equal, as many offers expire or have a limited number of uses.

The illustrated analytics data store 62 may store a plurality of records about historical interactions with the offers engine 12, such as aggregate statistics about the performance of various offers. In some embodiments, the analytics data store 62 stores a plurality of transaction records, each transaction record identifying an offer that was accepted by a user at a merchant, the merchant, the time of presentation of the offer to the user, and an indicator of whether the merchant has compensated the entity operating the offers engine 12 for presentation of the offer to the user. Storing and auditing these transaction records is expected to facilitate relatively accurate collection of payments owed by merchants and identification of future offers likely to lead to a relatively high rates of compensation for prominent presentation based on past performance of offers having similar attributes.

The cache server 23 stores a subset of the data in the data store 24 that is among the more likely data to be accessed in the near future. To facilitate relatively fast access, the cache server 23 may store cached data in relatively high speed memory, such as random access memory or a solid-state drive. The cached data may include offers entered into the offers engine 12 within a threshold period of time, such as offers that are newer than one day. In another example, the cache data may include offers that are accessed with greater than a threshold frequency, such as offers that are accessed more than once a day, or offers accessed within the threshold, such as offers accessed within the previous day. Caching such offer data is expected to facilitate faster access to offer data than systems that do not cache offer data.

The illustrated control module 14, in some embodiments, controls the operation of the other components of the offers engine 12, receiving requests for data or requests to add or modify data from the API server 16, the web server 18, the ingest module 20, and the administration module 22, and instructing the data store 24 to modify, retrieve, or add data in accordance with the request. The control module 14 may further instruct the cache server 23 to modify data mirrored in the cache server 23. In some embodiments, the cache server 23 may be updated hourly, and inconsistent data may potentially be maintained in the cache server 23 in order to conserve computing resources. The control module 14 may further initiate the process 200 described below and facilitate data transfers to and from the mobile dispatcher 13.

The illustrated components of the offers engine 12 are depicted as discrete functional blocks, but embodiments are not limited to systems in which the functionality described herein is organized as illustrated by FIG. 1. The functionality provided by each of the components of the offers engine 12 may be provided by software or hardware modules that are differently organized than is presently depicted, for example such software or hardware may be intermingled, broken up, distributed (e.g. within a data center or geographically), or otherwise differently organized. It should be noted that when it is said content is sent, provided, or the like, to a client device, such discussion encompasses use of (e.g., sending links for) content delivery networks that host content geographically closer to users to reduce latency. The functionality described herein may be provided by one or more processors of one or more computers executing code stored on a tangible, non-transitory, machine readable medium.

As noted above, the system 10 may include a mobile dispatcher 13 designed to increase conversions of offers on mobile devices relative to the performance of mobile devices on conventional systems. The mobile dispatcher 13, in some embodiments, analyzes a variety of types of information to determine the best (or an improved, e.g., more likely to yield a conversion, relative to traditional systems) path for the user, including the following data (as described in greater detail below with reference to FIG. 2):
a) Conversion and yield rate for the merchant at which an offer is redeemable. Yield rate is the ratio of Orders to Visits. An Order is an order an end user places with a merchant. A Visit is a session or a series of one or more interactions a user takes with the web site during a time span where each interaction is within some duration, such as no less than 30 minutes after the previous interaction. Yield is typically used as a measurement because it controls for variability in Commission Rate and Average Order Value (AOV).
b) Data about the merchant's mobile ecommerce capabilities collected manually or (i.e., and/or) automatically; and
c) Questions the human reviewers are asked about the merchant's mobile ecommerce capabilities.

Based on the data collected, some embodiments of the mobile dispatcher 13 choose different paths to guide the user down, including the following:
a) Let the user continue shopping online;
b) Prompt the user to download the native mobile application for the merchant or the offers engine;
c) Prompt the user to save the coupon to their account;
d) Prompt the user to email or text the coupon to themselves;
e) Prompt the user to create an account or sign up for emails; or
f) Prompt the user to shop at a nearby retail location.

Embodiments may select the path based on expected (e.g., maximized expected) revenue, user success, a combination of both, or other factors.

Selecting paths to enhance conversion may be based on a variety of factors, in some embodiments:
a) Historical information gathered on the website documenting click through and conversion rate by merchant and platform (e.g., mobile or desktop), such that a given merchant and platform can be compared to average values. For instance, embodiments may determine merchant xyz is in the top quartile of conversion rate on mobile web or is on par or higher than desktop, and that this indicates they have a good mobile experience, making the system more likely to direct the user down a mobile redemption work flow. In contrast, when those numbers are under indexed, embodiments determine that users are not having a good result and select a different route, e.g., offering an interface by which the user emails the offer to themselves for redemption on a desktop computer later.
b) In some embodiments, a human reviewer may visit the merchant website and score it for mobile friendliness and usability;
c) Embodiments may automate review of the merchant website and emulate mobile user visiting and determine if it is different from a desktop site (e.g., indicating that the site is customized for mobile) and determining whether the site has attributes that tend to facilitate mobile ecommerce; or
d) Embodiments may determine whether the merchant has a native mobile app that supports ecommerce and, in response, direct the user to that mobile app, rather than the merchant's non-mobile website.

In some embodiments, the preceding aspects labeled a-d are example inputs to an algorithm executed when (e.g., in response to) someone visits a mobile webpage to decide which path to follow, e.g., whether to try to platform shift the user to get them to complete on a tablet or a desktop experience (e.g., email a coupon to them, save coupon to account, text to self, or other cross-device signaling technique). Another path that embodiments may select is to direct the user to the merchant's native application, suggest downloading the offer-discovery system's app 52, or suggest creating an account with the offer-discovery system to get a newsletter or get email alerts to get deals for that merchant. In some cases, each of these options may be scored more highly or selected based on a determination that a user likely has a high intent to purchase.

As described below with reference to FIG. 3, some embodiments may select a path upon inferring the user's intent, e.g., by determining the user is in shopping mode (with high intent to purchase) or in browse mode (with low intent to purchase). To determine whether the user is in browse mode, embodiments may make a determination based on one or more of the following (e.g., with a thresholded aggregate (e.g., summed) score with weightings for each factor below):
a) Geolocation of the user. If the user is in the store at which an offer is redeemable or in a shopping district, intent to purchase is determined to be high, versus away from those areas, intent is determined to be low;
b) Time of day. Applicants have empirically observed that browsing increases at certain times of the day, such as the lunch hour or the evening, as well as certain days of the week and year;
c) Product category. Types of products typically not purchased online or types of products typically purchased in store, like restaurants, are often indicative of browsing in many cases, particularly when viewed on a desktop (or other non-mobile device);
d) Search patterns. Searching for multiple stores in a category is often indicative of comparison shopping;
e) Session information. If a session includes more than a threshold number of merchants in a category, then embodiments determine that the user is likely browsing;
f) Landing pages. Searches for particular brand names is often a signal of purchasing intent.

Upon determining that a user is in browse mode, embodiments may select a different path for the user in response:
a) Send the user to a different experience selected to favor browsing over more targeted purchases;
b) Show the user offers for all merchants within a product category of an offer or merchant for which offers were requested; or
c) Shift the user to a product centric view, e.g., coupons for a women's Summer fashion collection highlighting hot products for Summer along with coupons.

To reduce latency when selecting content for users, certain steps may be done in advance as a batch process. Generally, consumers expect a response with low latency, so some embodiments make this decision in less than 50-milliseconds to avoid damaging the user experience (though embodiments may also take longer). In addition to batch processing (e.g., scoring merchant websites for mobile friendliness), embodiments may use a high-performance data structure that is keyed by merchant, such as a hash table for frequently accessed metrics with a key value based on the merchant identifier.

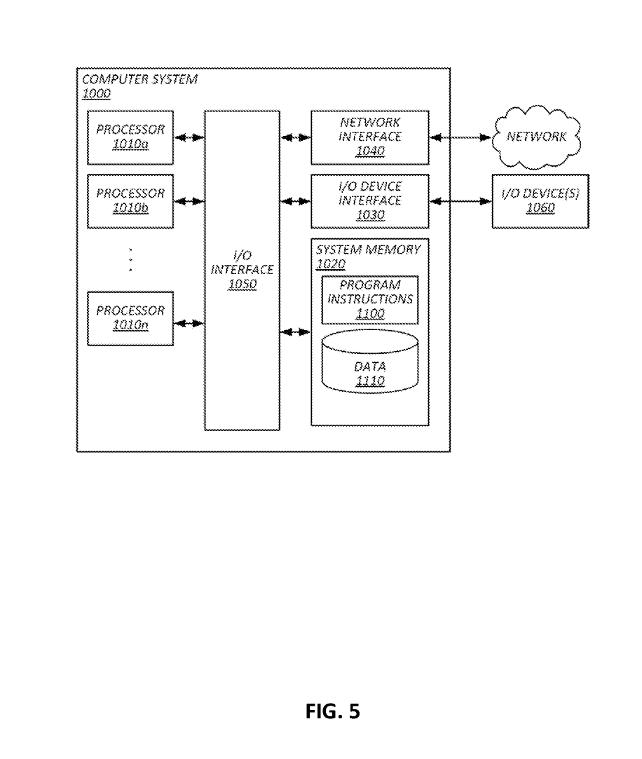

FIG. 2 shows an example of a process 200 that may be performed by some embodiments of the above-describe mobile dispatcher 13. The process 200 may determine whether a user of offer-discovery system is likely to have a poor experience on a mobile device and based on this determination adjust a work flow for redeeming offers to mitigate certain problems that often arise with the use of mobile devices to redeem offers. Instructions (e.g., computer code) for performing the process 200 may be stored on a tangible, non-transitory, machine-readable medium such that when instructions on the medium are executed by a data processing apparatus, an example of which is described below with reference to FIG. 5, the steps of process 200 may be performed. Similar encoding may be used for the other processes described herein. A single instance of process 200 is shown in FIG. 2, but it should be understood that in commercial embodiments, likely many instances, for example, several hundred or several thousand, instances of process 200 may be in various stages of execution simultaneously, as a user base numbering in the millions interacts with an offer discovery system to view thousands of different offers from hundreds of different merchants.

The process 200 begins in this embodiment with obtaining for a plurality of merchant websites a plurality of mobile-suitability values, as indicated by block 210. The plurality of merchant websites may be websites at which the offers described herein are redeemable, such as websites of retailers, restaurants, service providers, and various manufacturers. Each merchant website may be associated with a canonical URL prefix through which the merchant's website is accessible on the World Wide Web. In some embodiments, each merchant website may also be associated with a plurality of alias URLs that also can be used to retrieve the same website. Accounting for aliases may render the system more robust to variations in addresses used to redeem offers.

Each of the merchant websites may be associated with one or more mobile-suitability values specific to that merchant website. The mobile-suitability values may indicate whether the merchant website is suitable for redeeming an offer on a mobile user device. In some cases, the suitability values are a single value, such as a single Boolean value indicating whether the merchant website is suitable, or a value ranging from 0 to 10, with higher values indicating websites that are more suitable for offer redemption on mobile devices. In some cases, each merchant website is associated with multiple mobile-suitability values, each of which characterizes a different aspect of suitability, such as one value indicating suitability for relatively small screen sizes, such as screen sizes smaller than 5-inches on the diagonal, and another value indicating suitability for users having access to limited bandwidth, such as on a cellular network, for example, a value indicative of the cumulative amount of data to be downloaded to view the merchant's website. Thus, suitability may be characterized in a variety of different ways for each merchant website.

In some examples, mobile-suitability values are empirically determined based on historical conversion rates of mobile user devices for a given merchant's website. Some embodiments may store an offer log documenting previous instances in which an offer was sent to a user and that user's response (e.g., a list of transaction records in the analytics data store 62). In some cases, the log may include a plurality of offer-conveyance instance records (e.g., a super-set of the data in the transaction records), each record including an identifier of the offer, an identifier of the merchant, an identifier of a category of the merchant, an identifier of a category of a product to which the offer pertains, a date and time when the offer was conveyed, an indication of whether the user added the offer to a list of favorites, an indication of whether the user shared the offer, an indication of whether the user selected an input presented with the offer to redirect the user to the merchant's website (e.g., a click-through), and an indication of whether the user redeemed the offer at the merchant's website, an amount spent in the transaction in which the offer was redeemed, and attributes of the user device upon which the user viewed the offer. The identifiers described herein may be identifiers that uniquely identify the corresponding element in the system at issue.

A variety of different attributes of the user device may be stored, such as a Boolean value indicating whether the user device is a mobile user device and a value indicative of a screen dimension of the user device, such as a number of pixels, a pixel density, a number of inches of screen length or width, or the like. In some cases, the attributes of the user device may identify an operating system of the user device, for example, indicating whether the user device is executing an operating system associated with mobile user devices, like the Android™ operating system or the iOS™ operating system. In some cases, the attributes of the user device may indicate a version of the operating system or a version of a web browser or a native mobile application upon which the offer is to be viewed, such values indicating whether a user operating an older version of such products is more likely to have a worse experience on the mobile device. Some embodiments may store in memory a table assigning a user-interface constraint score to each configuration of user device. In some cases, the attributes of the user device may include specifications for hardware of the user device, such as a type of processor, a processing speed, or an amount of memory, such as an amount of cache memory, as such values may be indicative of whether the user is likely to have a poor experience on a mobile device. Some embodiments may store a value indicative of a location or velocity of the user, for example, obtained from a native mobile application executing on the user device upon which the user was viewing the offer, and such values may be used to determine whether other, similarly situated users are likely to have a poor mobile user experience, for example, due to traveling through the same area of poor cellular coverage.

In some embodiments, the merchants or products of offers may be categorized (e.g., in the offer logs or offer records), as certain categories of merchants offer products that users are less inclined to buy on a mobile device. For example, merchants selling televisions may be in a different category from merchants operating chain restaurants. In some cases, a given merchant may have multiple categories broken out by product, for example, a big-box retailer may have some products in a first category for which users are relatively disinclined to redeem offers on a mobile device and products in a different category for which users are substantially more likely to redeem offers on a mobile device.

In some embodiments, the offer logs may be processed to consolidate instances in which offers were conveyed into what are referred to as “unique instances.” Unique instances consolidate multiple instances in which an offer was conveyed within some threshold duration, such that the group of instances may be analyzed as a single conveyance. Often consumers view an offer, close their browser, come back within a few minutes, and review the offer to follow through on redemption. Consolidating instances in which an offer is conveyed within a relatively short duration of time may prevent the earlier viewings of the offer from artificially suppressing the conversion rate for the offer. In some embodiments, the duration of time is 30 minutes, though embodiments may use other durations, depending upon the shopping habits of users and the desired fidelity of measurement. Some embodiments may execute an algorithm by which instances in which a given offer is viewed are identified, then subsequent entries in the log are searched for additional viewings by the same user within some threshold duration. Upon finding such a viewing, embodiments may associate the subsequent viewing with the earlier viewing, such that later processes can identify unique instances in which an offer is viewed to calculate unique conversion or yield rates. Other embodiments, however, may not consolidate unique offer viewings, which is not to suggest that any other feature described herein may not also be omitted in some instances.

Some embodiments may calculate a mobile-suitability value by calculating a conversion rate based on the offer logs. For example, some embodiments may select entries in the offer logs indicating that the offer was viewed on a mobile device and calculate as a conversion rate the percentage of those selected entries in which the offer was redeemed, to calculate a redemption conversion rate, or the percentage of those selected entries in which the user clicked through on the offer to the merchant's website, to calculate a click-through conversion rate. In some cases, both types of conversion rates may be used as mobile-suitability values for a given merchant's website.

Merchants' websites often change over time. Accordingly, some embodiments may account for the age of the data with which conversion rates are calculated, down-weighting older data in the calculation. In some cases, only instances within some threshold trailing duration of the calculation are used to calculate conversion rates. In another example, a weight is assigned to each instance in which an offer was viewed based on the time since the viewing, with lower weights being assigned to older offers, and the weighted values are aggregated, for example, with an average, median, or other measure of central tendency to calculate the conversion rate.

As noted, some categories of merchants or products may tend to be more or less sensitive in conversion rate to use of a mobile device. Accordingly, some embodiments may calculate separate conversion rates for different categories of products associated with offers or different categories of merchants at which offers are redeemable. In some embodiments, the conversion rates are normalized by category of merchants or products. For example, some embodiments may determine the relative performance of a given merchant's website in conversion rate when compared to other merchants in the same category, or the relative performance of a given product of an offer when compared to other products in the same category. To this end, when calculating conversion rates, some embodiments may identify a subset of instances in which an offer was viewed in the logs where the offer pertains to the relevant given category of merchants or product and calculate a category conversion rate for products or merchants in the corresponding category. These embodiments may further calculate an individual conversion rate for the individual product or merchant website, and a measure of relative performance, such as a ranking within the category, a percentile within the category, or a score indicative of whether the specific product or merchant's website performs above some threshold value, such as in the top half of the group. In some cases, the relative performance measure may serve as a mobile-suitability value.

Some embodiments may calculate multiple conversion rates for each merchant website, each rate according to a type of user device upon which the merchant offers were viewed. For example, some embodiments may calculate a mobile conversion rate and a non-mobile conversion rate for a given merchant. In this example, the relative performance of the mobile conversion rate to the non-mobile conversion rate may serve as a mobile-suitability score that normalizes the conversion rate for aspects of the merchant's website, offers, and products that are unrelated to the user's device type. In another example, even finer grained conversion rates by device type may be calculated. For example, separate conversion rates may be calculated for different types of mobile devices, such as a conversion rate for mobile devices having a screen between six and seven inches diagonal, between five and six inches diagonal, and between four and five inches diagonal to identify merchant websites for which screen size is a important factor in conversion rate. In another example, separate conversion rates may be calculated for different operating systems of mobile device, different manufacturers of mobile device, different ages of mobile device, different versions of operating systems of mobile devices, different browsers or native applications of mobile devices, different versions of browsers or native applications of mobile devices, different processor types of mobile devices, or the like. As a result, some embodiments may calculate for each merchant website a plurality of values indicative of whether a particular mobile device having certain attributes is likely to yield a conversion.

Because merchant websites often change, and such changes may render historical measurements of conversion rates less reliable, some embodiments may monitor merchant websites for such changes, for example, by periodically downloading a merchants website with an automated browser (such as the Selenium™ automated browser) or a headless automated browser (such as the PhantomJS headless automated browser) and comparing the downloaded merchant's website to previously downloaded and stored versions of the merchant's website. To identify website elements indicative of a fundamental change in the merchant's website, some embodiments may download a plurality of versions of the merchant's website over time, identify website elements (e.g. document object model elements of the website as rendered in the automated web browser) consistent among the plurality of versions (thereby omitting frequently changed content that is not indicative of a substantial redesign), and then determine whether new versions of the merchants website have the consistent elements. Upon determining that more than a threshold amount (e.g., number or percentage) of merchant website elements have changed, embodiments may remove from the offer instance logs earlier instances in which the offer was presented or down weight pre-website-redesign instances in the offer logs relative to newer instances subsequent to the redesign when calculating conversion rates. Automation may also include remote controlling web browsers running on an array of mobile devices. For example, a lab environment may be established with representative devices of each of a plurality of manufacturers, hardware revisions, operating systems, and browser versions. A testing system may use (e.g., command and receive results from) this array of devices to automatically visit the merchant's web site and perform scoring, etc. Automation may also include the previous procedure where software emulators or simulators (such as the Apple iOS Simulator or Android Emulator) are used to simulate or emulate the behavior of the mobile device.

In addition to, or as an alternative to conversion rates, some embodiments may use a human reviewer to evaluate merchant websites and determine mobile-suitability values for the merchant websites. For example, some embodiments may assign tasks to human reviewers through a crowd-sourcing platform, such as Amazon's Mechanical Turk™ platform. The assigned task may instruct a human reviewer to view a given merchant's website on a mobile device and enter into a user interface form their perception of the merchant's website on the mobile device along with a description of their mobile device, such as the above-described attributes of mobile devices. In some cases, the reviewer may be prompted to quantify attributes like the readability of text, the ease of use of buttons, the responsiveness, and the overall quality of the merchant's website when viewed on a mobile device. The user interface forms sent to the human reviewers, for example, a web form sent to a web browser of each of the human reviewers, may include instructions (e.g., JavaScript™) to return the results of the human review to the above-described mobile-dispatcher 13.

In some embodiments, each merchant website may be sent to multiple human reviewers, such as five or more, and embodiments may identify outliers reviews (e.g., discarding the lowest and highest score in each category) and calculate a measure of central tendency (e.g. a mean, median, or a mode) for each attribute that is reviewed. Some embodiments may calculate an aggregate score, for example, by summing scored values or assigning weights to each of the attributes and calculating a weighted sum for each merchant website for use as a mobile-suitability score. In some cases, the techniques described above with respect to conversion rate calculations for calculating finer-grained suitability scores according to the age of data, the category of merchant, the category of product, or attributes of the user device may be applied to the human review scores, for example, obtaining human review scores for a range of different types of mobile devices, down-weighting older human review scores, or normalizing human review scores by category of merchant or product. In some cases, human review may be initiated in response to the result of the above-described technique for determining that a merchant's website has changed.

In addition to or as an alternative to the above-described mechanisms for calculating mobile-suitability scores, some embodiments may algorithmically evaluate merchant websites, for example, with an automated web browser, for mobile suitability. In some embodiments, the mobile dispatcher 13 may maintain in memory a list of merchant websites and periodically execute an automated web browser with a script configured to download and render each of the merchant websites in the list. Because some merchant websites are constructed with JavaScript™ instructions that add content to the document object model, some embodiments may be configured to render the downloaded content and execute associated scripts, rather than merely retrieving HTML responses to a given request to a merchant server.

In some cases, each merchant website may be retrieved and automatically evaluated under a number of different test conditions. For example, the automated web browser may be configured to iterate through configurations that emulate a variety of different attributes of mobile devices, like those attributes described above. For instance, some embodiments may request the merchant website with a hypertext transport protocol (HTTP) request that includes different user agent strings. User agent strings generally indicate to a receiving server attributes of the device requesting content. Some merchant servers may be configured to provide different versions of a website to accommodate different types of user devices as indicated by the user agent strings. Further, some merchant websites may send to the user device as part of sending the merchant website instructions to query the client web browser or operating system of the mobile device for attributes of the mobile device and report back those attributes to the merchant website server. Examples include JavaScript™ commands to obtain dimensions of a window object in a web browser executing on the mobile device and return those dimensions to the merchant server.

Based on the information sent to the merchant website, the merchant website may customize content for the attributes of the device requesting the content. Accordingly, some embodiments may emulate different window dimensions, operation systems, device types, or other client-device attributes to sample the merchant website under different conditions likely to be experienced by at least some users of mobile devices. In some cases, the presence of different versions of the merchant's website for different attributes of the user device may be used as a mobile-suitability value, with custom content correlating with higher-mobile-suitability scores. A similar result may be output in response to the merchant attempting to redirect the user to a merchants mobile native application, as such applications tend to be designed from the ground up to be suitable for mobile devices.

The various versions of the merchant website obtained by the automated web browser may be evaluated with a variety of different techniques to indicate the degree to which the merchant website is suitable for a mobile device. In one example, an amount of information density may be calculated, such as a number of characters displayed per square inch of screen of a client device, with higher information density generally correlating with lower suitability for mobile devices. In another example, the size of user interface elements may be determined, such as the size of buttons or other selectable elements in the merchant's website, like text-box inputs, with smaller user interface elements correlating with lower mobile-suitability scores. In some embodiments, a ratio of button size to screen size is calculated as a mobile-suitability value, or an average of the size of the buttons on the screen divided by the screen size is used as a mobile-suitability value. In some cases, the merchant website may be searched for types of the event handlers that tend to perform poorly on mobile devices, such as user interface elements activated by a user mousing over an element, interaction which tends to perform poorly on some touchscreen devices. Some embodiments may reduce the mobile-suitability score based on the presence of such user interface elements or output a Boolean value of false indicating that the merchant website is not suitable for mobile devices.

A variety of different techniques for determining mobile-suitability scores have been described. In some cases, these techniques may be combined, for example, with empirically-determined weightings to calculate a weighted aggregate mobile-suitability score (e.g., a weighted sum). In some embodiments, the aggregate mobile-suitability score may be compared to a threshold, and the result of the determination may indicate whether the merchant website is suitable for use on a mobile device. In other examples, attributes of an offer and a mobile device may be used to select a relevant mobile-suitability value among a plurality of such scores for a given merchant's website, and the selected mobile-suitability value may be compared against a threshold to determine whether the merchant's website is suitable for a mobile device given the current type of user device at issue and the current type of product or category of merchant, as is described further below with reference to step 220.

Calculating mobile-suitability values may be a relatively time-intensive and computation-intensive process. Indeed, some embodiments may calculate offer-specific mobile-suitability values, yielding hundreds or thousands of values per merchant. In some cases, the number of merchant websites and permutations of products and viewing scenarios may number in the hundreds of thousands or millions. Accordingly, some embodiments may schedule evaluations of suitability values periodically, for example, monthly, or some embodiments may initiate re-calculation of mobile-suitability scores in response to detecting that a merchant's website has changed using the techniques described above.

Applicants have observed that consumers tend to be relatively sensitive to even minor increases in latency when responding to requests for offers (for example, on the order of 100 ms). Thus, while the mobile-suitability values may be stored in a variety of different data structures, some embodiments may store the values in data structures selected to facilitate relatively fast retrieval. In one example, the values are stored in a hash table that is keyed to a hash function that takes as input an identifier of a merchant, attributes of a user device upon which the merchant's website is to be viewed, a category of merchant, offer, or a category of product to which an offer pertains. In another example, multiple instances of a set of scores may be stored, each instance being indexed to a different value by which the scores may be retrieved (e.g., by merchants, or offer) and sorted by that value to facilitate relatively fast binary searches.

Next in the process 200, some embodiments may receive, over a network (e.g. the Internet), from a remote mobile computing device of the user, a request for offer content that causes the mobile computing device to display an offer, as indicated by block 212. In some cases, the request may be a request to the web server 18 described above from a web browser executing on the mobile computing device, for instance, a request that is encoded as an HTTP GET request at a URL with parameters that identify a specific offer, request offers having particular criteria, or requests offers generally. In another example, the request may be a request from a native mobile application, like the native application 52 described above to the API server 16 described above and specifying an offer, requests for offers having particular criteria, or requests for offers generally.

Some embodiments may determine whether the request is a request for online or in-store offers and continue with process 200 in response to determining that the offer request is a request for online offers, as in-store offers are often designed for presentation on mobile devices, whereas online offers are more likely to be designed for viewing on a desktop computer. In some cases, the process 200 may include a step in which the mobile dispatcher 13 determines whether the request is from a mobile device, for example, based on a user agent string encoded with the request, the user agent string indicating, for instance, the version of an operating system associated with mobile devices in memory of the dispatcher 13. In another example, a request may be determined to be from a mobile device based on a user making a request with a native mobile application. The process 200 may continue in response to determining that the request is from a mobile device. Alternatively, embodiments may send the user a display of the offer without attempting a platform shift as described below.

It should also be noted that embodiments are not limited to smart phone versus non-smart phone selections of redemption work flows. Other mobile devices may present other user interface challenges to which the present techniques are relevant. For example, user interfaces associated with wearable computing devices, like heads-mounted displays and smart watches, in some cases, present even more severe constraints than smart phones. Further, embodiments are not necessarily limited to mobile versus non-mobile selections of redemption work flows, as some user devices present different constraints for which different redemption work flows may be dispatched. For example, users of set-top boxes and game consoles often do not have access to a physical keyboard, and embodiments may choose different redemption work flows in response to use of the present techniques to detect a low-suitability value for the corresponding user device.

Next in process 200, some embodiments may ascertain a selected merchant website from among the plurality of merchant websites at which the offer is redeemable, as indicated by block 214. In some cases, ascertaining the selected merchant website may include receiving an indication of a particular offer selected by the user and determining based on an offer record which merchant redeems the offer, e.g., by selecting a merchant record.

Next in process 200, some embodiments retrieve, from the plurality of mobile-suitability values, a selected mobile-suitability value for the selected merchant website, as indicated by block 216. As noted above, in some embodiments, multiple values may be retrieved for a given merchants website, and some embodiments may retrieve context-specific values for the merchants website, such as values that correspond to attributes of the particular user device requesting the offer content, values that correspond to the particular offer for which content is requested, or values that correspond to the particular category of merchant or product pertaining to the offer requested.

Next in process 200, some embodiments may obtain, from the mobile computing device, data indicative of user-interface constraints of the mobile computing device, as indicated by block 218. Such values may be obtained, for example, in a user agent string conveyed with an HTTP GET request for the offer content from a web browser of the mobile computing device. In some cases, the user agent string identifies a web browser, a version of the web browser, and a type of computing device of the mobile computing device requesting the offer content, such as a version of operating system. In some embodiments, the mobile dispatcher 13 may respond to a request by sending to the mobile computing device instructions, such as JavaScript, that when executed by a web browser of the mobile computing device queries the web browser for attributes of the mobile computing device, such as window or screen dimensions, and send those values back to the mobile dispatcher 13. These returned values may be correlated with user-interface constraint scores in memory (e.g., in a lookup table) of the mobile dispatcher 13.

Next, embodiments of the process 200 may determine whether the user is likely to experience impaired mobile user experience, as indicated by block 220. In some embodiments, the determination is based on the user-interface constraints of the mobile computing device and the selected mobile-suitability value for the selected merchant website. In some cases, the determination includes a binary decision of whether the mobile computing device constitutes a mobile device based on some or all of the user-interface constraints and, if the mobile computing device is determined to be a mobile device, determining whether a mobile-suitability value is true or false, indicating whether the selected merchant website is suitable for mobile device. Other embodiments may make more complex determinations. For example, a mobile-constraints score may be calculated (e.g., retrieved from a pre-calculated look-up table or computed) based on the obtained user-interface constraints. A weighted aggregate value may be calculated based on a weighted aggregation of screen size, processing power, and conversion rates calculated for the particular type of mobile device relative to other devices (e.g., a relative percentile). The resulting mobile-constraints score may be compared to a mobile-suitability value, and the determination 220 may depend on whether the mobile constraints score exceeds the mobile-suitability value, thereby indicating at the merchant website is not suitable for the particular mobile device in question.

Upon determining that the user will likely not experience an impaired mobile user experience, embodiments may send the offer content to the mobile device using the techniques described above with reference to FIG. 1 or below with reference to FIG. 4 and return to block 212 to await the next request for offer content.

Upon determining that the user will likely experience an impaired mobile user experience, embodiments may proceed to send instructions to present a platform-shift user interface to the mobile computing device, as indicated by block 222. A platform-shift user interface may include one or more user-selectable inputs that facilitate redemption of an offer on different computing devices or different platforms from the selected merchant website. For example, the user may be presented with an input that when selected causes an email describing the offer to be sent to an email of the user stored in a user profile. In another example the user may be presented with an input that when selected causes a short message service text message describing the offer to be sent to a phone number stored in a user profile. Or some embodiments may determine whether such a profile exists and solicit the corresponding information in response to determining that the system does not store the appropriate email address or phone number. In some cases, the user may be presented with an input that when selected causes adding the offer to a list of favorite offers stored in the user's account, adding the offer to a card-linked offer account, or adding the offer to an electronic wallet account of the user. In another example the user may be presented with an input that when selected causes the mobile device to download a native mobile application for the merchant or the offers engine. In another example the user may be presented with an input that when selected causes the user to be enrolled for updates (e.g., email updates) related to the offer.

Embodiments are not limited to sending a platform-shift user interface in response to determining that the user will likely experience an impaired mobile user experience. Some embodiments may send other content, such as other user interfaces, selected based on the determination that the user will likely otherwise experience an impaired mobile user experience. The content that is sent may be the content suitable for the mobile computing device, like content that satisfies the user-interface constraints of the mobile computing device, for instance, content that does not include unsupported user interfaces and includes an information density below a threshold suitable for the target audience (e.g., as determined by empirically testing various densities on users in the audience and surveying those members for their perception of the content). A variety of types of content may be sent, including content that is consistent with at least some aspects of the offer the user sought to view or redeem. For example, the user may be presented with a recommendation to proceed using the merchant's non-mobile website rather than the merchant's mobile website. In another example, the user may be presented with a recommendation to purchase from a different merchant that offers the same or similar products and/or discounts but which has a higher mobile suitability value.

The above-described platform-shifts may shift the user's engagement with the offer to another platform in which the user is more likely to redeem the offer than the user would be on the current mobile user device. These targeted platform shifts are expected to save consumers money by facilitating greater usage of offers discovered on mobile devices and enhance merchant's engagement with users by distributing the experience across multiple devices or accounts over time.

FIG. 3 shows an example of a process 300 that customizes the user experience for those interacting with offers based on an inferred intent of the user. Some embodiments infer whether the user is viewing offers with the intent to purchase or viewing offers with the intent to browse instead. Often users making identical requests for offers do so with different purposes in mind and having needs that are better satisfied by different presentations of offer content. In some cases, the process 300 may be executed by the above-describes mobile dispatcher 13 to offer such customization (which is not to suggest that the process is limited to use with mobile devices). As with the other processes described herein, the process 300 may be encoded as program code on a tangible, machine-readable, non-transitory medium, such that when the program code is executed, a data processing apparatus executing the code may perform the steps of process 300. Further, it should be noted that in commercial-scale embodiments, the process 300 may be executed tens, hundreds, or thousands of times simultaneously in differing stages of execution as a typical user base is serviced.

Some embodiments of the process 300 may include obtaining a purchase-intent model, as indicated by block 300. Purchase-intent models may include formulas or other algorithms by which a score is calculated that estimates the likelihood that a user shopping with the intent to purchase rather than with the intent to browse for goods and services. Inputs to the model may include a geolocation of a user requesting content, a time during which the user requests offer content, a product category for which the user request offer content, and a search history of the user requesting offer content. These inputs may be combined in a variety of fashions to yield a score indicative of purchase intent. For example, sub-scores indicative of the state of the various inputs may be multiplied by respective weighting coefficients, and the weighted sum may be calculated to yield a purchase-intent score for comparison with a threshold. In another example, each of the sub-scores may be separately compared against a threshold, and a cumulative number of sub-scores satisfying the threshold (exceeding or falling under, depending upon the scoring system in use) may be determined as an aggregate score. For example, some embodiments may infer purchasing intent when three out of four sub-scores exceed respective thresholds. Embodiments may use a subset of these inputs, such as any permutation of the listed inputs, and some embodiments may use additional inputs, which is not to suggest that any other feature described herein is limited to the features recited or requires the features recited in all embodiments.

Inferences may be drawn from the geolocation of the user requesting offer content with a variety of different techniques. For example, some embodiments may determine whether the user is within a geo-fence corresponding to one or more retail stores, such as a geo-fence encompassing a shopping mall. In response to determining that the user is within such a geo-fence, embodiments may determine a geolocation sub-score favoring a conclusion that the user intends to purchase goods rather than intends to just browse, as users often are more inclined to purchase when near stores at which the purchases can be executed. Some embodiments may determine whether the user device is receiving a wireless beacon indicative of a particular geolocation. In another example, a distance between a geolocation of the user requesting offer content and a geolocation of a merchants store at which the requested offer content is redeemable may be determined. Some embodiments may determine a geolocation sub-score based on such a distance, for example, determining whether the distance exceeds a threshold, as users are often more inclined to purchase when near stores at which purchases can be made. In some embodiments geo-fences of stores (e.g. collections of latitude and longitude coordinates defining a bounding polygon, or center point latitude and longitude coordinates with radii specifying bounding circles) may be stored in association with merchant records in the various data stores described herein.

In some cases, sub-scores may be calculated based on a time of day during which the offer content is requested by the user. The relevant time of day may be the time of day in the geolocation from which the request is received, as users often tends to have higher purchasing intent during certain times of day, times of the week, and times of year. For example, some embodiments may assign a higher sub-score to an offer received from a geolocation at which the time of day is determined to be in the evening relative to a request from a geolocation at which the time of day is in the morning, as users often are more inclined to purchase in the evening. Some embodiments may include a plurality of lookup tables, each lookup table including a plurality of bins of time, and each bin corresponding to a different sub-score for that lookup table. In some cases, a lookup table is maintained for daily cycles, weekly cycles, monthly cycles, and yearly cycles, such that some embodiments may be operative to assign higher sub-scores to requests for offers received on Mondays, in the evening, within a month before the Christmas holiday, relative to sub-scores for a different day of the week, a different time of day, or different time of year, for example.

In some cases, purchase intent may be inferred from a category of offers to which the request for offer content pertains. For example, consumers searching for certain categories of goods or services are often more inclined to purchase those goods or services, rather than merely being browsing. In another example, consumers requesting off-line coupons or printable coupons may be inferred to have a different intent relative to consumers requesting online offers. Similarly, requests for offers from certain categories of merchants, such as big-box retailers, or sporting-goods stores may tend to have a different purchase intent in the aggregate. Accordingly, some embodiments may maintain one or more lookup tables in which different categories are mapped into different purchase-intent sub-scores. In some cases, different values in the table are maintained for mobile and non-mobile device requests for content, as some categories are a stronger signal of purchase intent when requested on a mobile device than on a desktop device.

Search history of the user requesting offer content may also be indicative of purchase intent. For example, some embodiments may calculate a sub-score based on whether the user has requested offers from more than a threshold amount (e.g. five) of merchants in a particular category of merchants (e.g. women's clothing retailers) within a duration of time (e.g. within the preceding hour), as users are often more likely to be browsing when viewing offers across a number of different merchants. In another example, requests for offers pertaining to a specific merchant may be indicative of higher purchase intent.

The resulting sub-scores may be combined, for example with weighting coefficients, as a weighted sum to yield a single score in some embodiments. In some cases, interaction variables (e.g. the sum, product, or average of any two or more of the sub-scores) are also associated with weighting coefficients and added to the sum. For example, an interaction variable for each unique pair of sub-scores and an interaction variable for each unique combination of three of the sub-scores.

In some cases, the purchase-intent models may be constructed as a batch process run periodically based on offer logs like those described above. Pre-building the models, before those models are used to service requests for offer content, is expected to expedite responses and improve the user experience for latency-sensitive users. Some embodiments may construct the model by, for example, initializing the model with randomly selected weighting coefficients; calculating a cumulative error amount with which the model describes the existing log data; and iteratively performing a gradient descent optimization procedure to reduce the error amount (e.g., rate) and select appropriate weighting coefficients and threshold value (e.g., repeating the optimization procedure until a change in the error amount between iterations is below a threshold amount). To mitigate the risk of local minima, some embodiments may repeat the gradient descent optimization with multiple initial random values to confirm that iterations converge on a likely local minimum error amount. The resulting weighting coefficients and threshold may be stored in memory as constituents of the model.

Next, some embodiments of process 300 may receive, via a network (such as the Internet), a request for offer content from a computing device of the user (examples of which are described above with reference to FIG. 1), as indicated by block 312. In some cases, the request is a request from a mobile device or a desktop device of the user for web content hosted by an offers engine or affiliate-network system, like those described elsewhere in this document. In some cases, the request is a request to an application program interface of such an offers engine by a native application executing on the user device. In some embodiments, the request may include information that indicates the type of user device and the location of the user device. For example, native mobile applications may be configured to sense a geolocation of the mobile device and send such a location with requests for offer content. In some cases, requests for offer content may also be geolocated based on an Internet Protocol address of the requesting device. In some embodiments, a request is received with an identifier of a user profile in which a geolocation previously entered by the user in defining their profile is stored. Some embodiments may use the profile geolocation as the geolocation of the request.

In response to receiving the request, some embodiments may calculate, with one or more processors, a purchase-intent score with the purchase-intent model based on the request for offer content, as indicated by block 314. In some embodiments, this calculation may include calculating sub-scores using the techniques described above and including those sub-scores into a formula or other algorithm, such as a weighted sum, by which the sub-scores may be aggregated into a purchase-intent score.

Next, some embodiments of process 300 may determine whether the purchase-intent score satisfies a threshold, as indicated by block 316. Depending upon the sign assigned to the purchase-intent score, satisfying the threshold may include determining whether the purchase-intent score is above a threshold value or below a threshold value.

Next, some embodiments of process 300 may select offer content based on the determination that the purchase-intent score satisfies the threshold, as indicated by block 218. In response to a determination that the user is likely shopping with intent to purchase, some embodiments may execute the process described above with reference to FIG. 2 to avoid a lost conversion on a mobile device if the user is requesting offer content from a mobile device. For example, upon determining that the user is likely shopping with intent to purchase, some embodiments may attempt to platform-shift the user with the above-described platform-shift user-interface, selecting such an interface to send as part of the offer content.

Alternatively, upon determining that the user is likely shopping with intent to browse, some embodiments may select offer content that spans a broader range of offers in the area in which the user is browsing. For instance, upon inferring that the user is browsing, embodiments may determine a category of goods or services in which the user is browsing and, then, select offers pertaining to goods or services in that category for display, for example, spanning a number of different merchants. In one use case, a user may be browsing Fall women's clothing generally, and embodiments may select offers relevant to such goods. In some cases, the selected offers may span a plurality of merchants and fall within a single category of products or services.

Next, embodiments of the process 300 may send the offer content to the computing device of the user, as indicated by block 320. Sending content selected based on the user's browsing or purchase mode is expected to better target offer content to the needs of users and yield higher conversion rates than traditional techniques. That said, not all embodiments necessarily perform the process 300, as the present application describes a number of techniques that are independently useful.

FIG. 4 shows a computing environment 410 having an embodiment of an affiliate-networking system 412 that may include the mobile dispatcher 13 described above. In some case, the affiliate-networking system 412 serves the role of the affiliate network servers described above with reference to FIG. 1. In some embodiments, the affiliate-network system 412 is configured to distribute and track offers that are (for some offers) each redeemable on-line and off-line, which includes in-store redemption and redemption through other devices or accounts:
a. To accommodate the different display capabilities of various accounts and devices, some embodiments receive, from a merchant, and implement specifications for an offer that define, at least in part, how the offer is to be displayed in each of a variety of different modes of presentation, such as on a desktop computer web browser, on a tablet computer native application, on a smart phone, in print, in email, and in short message service text messages, to name a few examples.
b. To facilitate tracking, some embodiments host offer content that publishers embed in their websites, native applications, or other publisher content. In some cases, the offer content returns to the affiliate-network system user interactions with offers (e.g., selections of buttons and the like) that may be tracked both when the user pursues on-line redemption and off-line redemption.
c. To reduce the complexity of managing multi-channel offers for merchants, publishers, and consumers, some embodiments store data about an offer with reference to a single offer record, such that multiple forms of interaction and presentation are readily tracked, configured, or otherwise managed, with reference to the single record.
d. To reduce complexity for those distributing offers, some embodiments are configured to provide multi-channel access to an offer through a single uniform resource identifier (URI) corresponding to the offer, such that a request for offer content identifying the URI (e.g., when a consumer's web browser encounters the URI embedded in a publisher's website) yields offer content configured according to the type of device or account to which the offer content is directed. Using a single URI for differently formatted presentation of an offer is expected to simplify offer management for both consumers and publishers, as format-specific URI need not be tracked by these parties.
e. To facilitate tracking of multi-channel offers, some embodiments are configured to provide analytics to both merchants and publishers that aggregate both on-line and off-line consumer interactions, such as redemptions.
f. To facilitate control of multi-channel offers, some embodiments execute routines specified by merchants for dynamically adjusting the terms of offers based on feedback from multiple channels of offer redemption, including on-line and in-store redemptions.

Thus, some embodiments of the affiliate-network system 412 address a variety of different problems associated with the use of offers that are redeemable both on-line and in-store. Each of these solutions, however, need not be included in every embodiment, as some embodiments may address only some of the above-described problems with existing affiliate-network systems, which is not to suggest that any other feature described herein may not also be omitted in some embodiments.

Operation of the affiliate-network system 412 is better understood in view of the other components of the computing environment 410 with which the system 412 interacts. As illustrated by FIG. 4, embodiments include the mobile dispatcher 12, the Internet 414, merchant systems 416, publisher servers 418, and consumer user devices 420. The components of the computing environment 412 connect to one another through the Internet 414 and various other networks, in some cases, such as cellular networks, local area networks, wireless area networks, and the like. While three of each component 416, 418, and 420 are illustrated, it should be understood that embodiments with substantially more of these devices are contemplated. For example, likely applications include tens of millions of consumer user devices 420, tens of thousands of publisher servers 18, and hundreds or thousands of merchant systems 416.

The illustrated merchant systems 416 may each correspond to a different merchant and may each include a variety of different types of computing devices used by the respective merchants in the course of business. Merchant systems 416 may include merchant web servers that host merchant websites. In some cases, it is the merchant websites to which consumer user devices 420 are directed for on-line redemption of offers and to view goods or services associated with offers. Merchant systems 416 may also include user devices of merchant employees that interact with the affiliate-network system 412 to configure new offers, reconfigure existing offers, view analytics associated with offers and publishers, and otherwise control offers issued by the respective merchant. Merchant systems 416 may also include point-of-sale terminals and electronic kiosks located at the physical sites of the respective merchant, such as at retail stores or service centers. Systems 416 may also include merchant databases connected to those point-of-sale terminals for storing financial-transaction records associated with transactions with, e.g., sales to, consumers. The merchant systems 416 may be configured to automatically, or at the direction of the merchant's employees, upload transaction records from the merchant's database to the affiliate-network system 412. These uploaded transaction records, in some embodiments, are used to determine compensation for publishers based on in-store redemptions of offers by consumers, the compensation rewarding publishers who potentially made the consumers aware of the offers as indicated by records in the affiliate-network system 412. Often, merchant systems 16 are geographically distributed, for example, having point-of-sale terminals in multiple stores of a retail chain, and having a merchant database and employee user devices in a central office of the respective merchant.

The publisher servers 418, in some embodiments, serve publisher content (e.g., web pages, data for display with a native application on a mobile device, set-top box, in-store kiosk, or the like). In some cases, the publisher content is served to consumer user devices 420 and includes instructions to retrieve and display offer content from the affiliate-network system 412. In some cases, the offer content is embedded in the publisher's content, e.g., with URI's in a publisher's webpage that cause a web browser to retrieve and embed content from the affiliate-network system 412 bracketed with an HTML “embed” tag, an i-frame, or other instructions that cause content from outside the publisher's domain to be displayed. In some cases, the offer content is not embedded and is referenced by linking or re-directing to the affiliate-network system 412. Or, in some cases, the publisher servers 418 serve offer content directly to consumer user devices 420.

The publisher content, in some cases, is web content, like websites having webpages in which multiple offers are referenced or included. In some cases, consumers seek out the websites of publishers because the publishers curate offers on behalf of the consumers (e.g., selecting offers based on quality, success rate, subject matter, or the like). Publisher servers 418 may provide, in the publisher content, interfaces by which consumers can share data indicative of the efficacy or applicability of offers, for example, by indicating success rates for offers, providing content or comments about offers, rating offers, categorizing offers, or up-voting or down-voting offers. In other cases, the publishers servers 418 host content that is not specific to offers, such as webpages about particular areas of interest, like sporting goods, electronic devices, home goods, fashion, current events, or the like, and the publishers includes links to offers curated with that publisher's audience in mind.

In other cases, the publisher servers 418 host a publisher application program interface (API) that services native applications on consumer user devices 420 (which may include public devices, like kiosks). For example, some publishers may offer a (non-web-browser) native application on a smart phone or tablet that is down-loadable from a user-device maker's service for providing approved applications. Examples of such applications include barcode-scanning applications by which a user captures an image of a product barcode with a camera of the consumer user device 420, and the application converts the image into a product stock-keeping unit (SKU), which is then submitted to the publisher server 418 for retrieving offers related to the SKU to be displayed on the consumer user device 420.

In another example, the application includes an application specifically for viewing offers. In some cases, the native application may be configured to interact with a user account hosted by the publisher server 418 (which may include a plurality of computing devices, such as a user profile database and offers database) by which the user can view offers that they previously designated as favorites or view offers that friends of the offer user (e.g., as registered in a social network to which the server has access) have identified to the offer user. Such native applications for viewing offers may further include various tools by which the user can readily view and navigate through a plurality of offers, for example, including searching tools, faceted search, and lists of curated offers. In some cases, the native application is configured to obtain a geographic location of the user device, for example, with a GPS sensor or other location determining service accessed by the operating system of the consumer user device, and request offers based on the geographic location from the publisher server 418, such as in-store offers for merchant stores that are near (e.g., within a threshold distance to or ranked based on a location of) the consumer user device. In some cases, the offers satisfy various other criteria, for example, corresponding to a user profile indicating the types of offers in which the user is likely to be interested. In other cases, a native application on the consumer user device may serve any of a variety of other functions for the consumer, and that native application presents offers as advertisements to subsidize the cost of providing that service.

The consumer user devices 420 may be any of a variety of different types of computing devices through which consumers access the Internet 414. Examples of such computing devices are described below with reference to FIG. 5. In some cases, a given consumer user device 420 is a smart phone, tablet computer, laptop computer, or desktop computer. Consumer user devices 420 include a processor and memory and may execute an operating system in which a web browser or native application executes for viewing offers. In some cases, the consumer user device 420 is a mobile user device, which includes a portable power supply, like a battery, a fuel cell, or a solar energy source, such that the consumer can carry the user device into a merchant's physical store for in-store redemption. In some cases, such mobile user devices include a wireless interface, such as Bluetooth™, a near-field communication (NFC) interface, or a wireless area network interface, by which the consumer user device exchanges information with the point-of-sale terminal about offers being redeemed, such as an offer identifier. Further, in some cases, the mobile user device includes a display by which an identifier of the offer to be redeemed is presented and is entered into a point-of-sale terminal, for instance, by a sales clerk viewing the display and manually typing in the offer identifier (e.g., an offer code), or by the sales clerk scanning the display with a barcode scanner or an optical scanner. In other cases, the consumer user device is not mobile and includes a relatively large display, for example, a desktop computer or a set-top box connected to a television with a screen larger than 10-inches measured diagonally. In some cases, consumer user devices 420 include an application specifically for viewing offers (e.g., a native application executing on a set-top box, like a gaming console or streaming media device) or include a web browser by which the user navigates to a publisher's website for viewing offers and to a merchant's website for redeeming offers. Consumer user devices 420 may be any of a variety of types of electronic devices connected to the Internet 414 by which users are made aware of, store, or obtain information about offers, including smart watches, head-mounted displays, networked appliances (e.g., Internet-enabled refrigerators), or public computing devices, such as an in-store kiosk.

As noted above, in some cases, offer content viewed on consumer user devices 420 is identified to consumers by publisher servers 418, but is hosted by the affiliate-network system 412. For example, publisher servers 418 may send consumer user devices 420 a webpage listing a plurality of offers, and each offer listing may include an instruction to the consumer user device 420 to retrieve offer content from the affiliate-network system 412 corresponding to the offer, for example, a URI of the respective offer that directs the consumer user device 420 to retrieve content from the affiliate-network system 412. Offer content may include various offer resources by which views of offers are constructed, such as mark-up information, templates, images, offer terms, coupon codes, and interfaces for interacting with the offer (e.g., buttons and scripts executed when buttons are selected to effectuate selected actions). The offer content may be hosted by the affiliate-network system 412, rather than the publisher server 418, to facilitate tracking of offer interactions (e.g., redemptions, sharing, printing, or sending to another device or account) across both on-line and off-line redemption channels. Or, some embodiments host the offer content on the publisher servers 418 instead of, or in addition to, the affiliate-network system 412.

Thus, in some cases, the display of an offer on a consumer user device 420 may be preceded by the consumer user device 420 requesting content from the publisher server 418, receiving that content, determining that the content includes instructions to request offer content from the affiliate-network system 412 on a different domain from the publisher server 418, and executing those instructions, to retrieve the offer content. In some cases, the instructions from the publisher server 418 to request offer content do not specify the type of user device or type of account in which the offer will be viewed. Rather, in some embodiments, a single instruction, such as a single URI per offer, is provided by the publisher server 418 regardless of the type of consumer user device or the account, thereby relieving publishers of the burden of maintaining multiple, different instructions for a single offer for each of the various potential viewing options. In response, the consumer user device 420 may request content according to this instruction, for example with the URI. In response, the affiliate-network system 412 may determine based on the request and, in some cases, additional information about the consumer user device 420 or account, the appropriate offer content for the type of presentation in which the offer will be viewed or otherwise used.

In some embodiments, the affiliate-network system 412 includes a web server 422, an API server 424, a controller 426, an affiliate-network data store 428, a content-negotiation module 30, a dynamic-terms offer controller 432, and an analytics module 434. These components are illustrated and described as discrete functional blocks, but it should be understood that code or hardware by which this functionality is provided may be subdivided, intermingled, conjoined, or otherwise differently arranged. Further, it should be understood that one or more computing devices, and in many embodiments, a plurality of computing devices, by which this functionality is implemented may be geographically distributed or co-located, for example, in a data processing facility. Further, it should be understood that some of the components and features of the affiliate-network system 412 may be omitted in some embodiments, which is not to suggest that any other feature is required in all embodiments.

In some embodiments, the web server 422 is operative to receive requests from web browsers executed by user devices of consumers, publishers, or merchants. In some cases, those requests include requests for, or interactions with, role-specific webpages, for consumers, publishers, or merchants. For instance, a merchant may request a webpage for specifying a new offer, viewing data about a previously specified offer, or adjusting attributes of an existing offer. In another example, the web server 422 may include code for providing a webpage with interfaces by which merchants create a new merchant account, view data about a merchant account, or adjust attributes of a merchant account. Similarly, the web server 422 may include code for providing a webpage with interfaces for specifying a publisher account, viewing a publisher account, or adjusting a publisher account. In some cases, these interfaces include buttons that when selected cause client-side scripts to communicate with web-server 422. Other example interfaces include text boxes, radio buttons, check boxes, and the like for data entry. Browsers executing on user devices may submit entered data and commands to the web server 422, which may advance the commands to the controller 426 for responsive action by the affiliate-network system 412. Similarly, the web server 422 may receive requests for resources from such user devices, for example, to form the corresponding webpages, and the web server 422 may advance requests for responsive content to the controller 426 for retrieving and returning the responsive content.

The API server 424, in some cases, may be configured to support programmatic interaction with the affiliate-network system 412 through programs (e.g., non-web-browser programs) executing on the publisher servers 418, the merchant system 416, or consumer user devices 420. The API server 424 may support a variety of commands to manipulate or retrieve data from the affiliate-network data store 428, examples of which are described throughout this document. In some cases, the API server 424 may be operative to receive a request for offers from a publisher server 418 and advance that request to the controller 426 which retrieves responsive offers from the affiliate-network data store 428. The API server 424 may return those offers to the publisher's server 418 from which the request was received. In some cases, the request specifies various criteria of the offers, such as geographic criteria, a category of offers, a type of redemption, a merchant, a category of merchant, or other offer attributes, and the API server 424 instructs the controller 426 to retrieve responsive offers satisfying the criteria. Similar requests may be received from the merchant system 416 or the user devices 420, depending upon the application. In some cases, the API server 424 is operative to receive and initiate responses to publisher or merchant requests for role-specific analytics, such as data for reports provided by the analytics module 434 described below. Other interfaces supported by the API server 424 may include, in some embodiments, upload functionality, by which merchants upload new offers programmatically, change offers programmatically, or upload transaction data describing in-store redemptions of offers. Similarly, in some cases, publishers may upload information about user interactions with the offers programmatically, or consumer user devices 420 may upload information about consumers or consumer interactions with offers programmatically, provided that the consumer has opted in to the appropriate privacy settings allowing such uploads.

In some embodiments, the controller 426 is operative to receive commands and data from the web server 422 or the API server 424 and coordinate responsive actions by the other components of the affiliate-network system 412. In some cases, the controller 426 is operative to translate web requests or API requests into corresponding data transformations and database interactions to store or retrieve implicated data.

In some embodiments, the affiliate-network data store 428 stores data about merchants, publishers, offers, and consumer interactions with offers. The affiliate-network data store 428, in some cases, is a relational database, or other types of data stores may be used, including hierarchical key-value stores, program state, and memory images. In this embodiment, the affiliate-network data store 428 includes a merchant data store 436, a publisher data store 438, an offer data store 440, and a tracking data store 442. In some cases, each of these data stores 436, 438, 440, and 442 may be separate databases or, in other cases, these data stores may be intermingled in a single database or other data store. The affiliate-network data store 428 may be operative to persistently store data about merchants, publishers, offers, and consumer interactions with those offers. In some cases, the affiliate-network data store 428 is configured to receive queries, for example, submitted in the form of structured query language from controller 426 and respond with responsive data. Similarly, the affiliate-network data store 428 may be responsive to commands from controller 426 to store data or delete data, e.g., when creating new records or changing records.

In some embodiments, the merchant data store 436 is configured to store data about merchants that use the affiliate-network system 412 to distribute offers and track interactions with those offers. In some implementations, the merchant data store 436 stores a plurality of merchant records, each merchant record corresponding to a different merchant account with the affiliate-networking system, and in some cases, corresponding to a different merchant. In some cases, each merchant record includes the following data: a trade name of the merchant; a business-entity name of the merchant; a unique merchant identifier by which the merchant record may be linked to other records in the affiliate-network data store 428; merchant-specific branding content (such as images of the merchant's logo at various resolutions, merchant tag-lines, merchant website URLs, or URIs of such content) for use in the merchant's offer content; analytics tags (examples of analytics tags include code or resources, like a tracking pixel, to be added to offer content, like an offer page, corresponding to the respective merchant's analytics system (e.g., Omniture provided by Adobe Systems, Inc. of San Jose, Calif., or Google Analytics provided by Google Inc. of Mountain View Calif., among others) that cause the user device to provide information with the merchant's analytics system, thereby allowing the merchant to measure performance of the offer content as if it was part of their own website or mobile application); geographic merchant locations (e.g., a plurality of site records, each site record corresponding to a brick-and-mortar site and having a location—like a street addresses of the store, latitude and longitude coordinates of the store, or coordinates of a polygon bounding the store—along with store hours, point-of-sale capabilities—like barcode scanning, optical scanning, and NFC capabilities that may be used to exchange data with consumer user devices during an in-store coupon redemption—and various merchant-defined categories) for selecting offers based on location or store-specific attributes; merchant categories (e.g., sporting goods, financial services, retail clothing, and the like) for selecting offers based on merchant specialty; supported coupon code formats (e.g., whether the merchant supports single-use coupon codes that are unique to a customer or customer session with a publisher or other coupon provider, or whether the merchant supports multi-use coupon codes that are widely distributed to multiple users) for determining offer configuration options for a merchant; merchant contact information (e.g., a plurality of employee records, each record having a name, password, role, phone number, email address, and permissions to interact with the affiliate-network system 412 on behalf of the merchant) to facilitate controlled distribution of offers by authorized employees of the merchant; and pre-approved publishers (e.g., publisher identifiers corresponding to records in the publisher data store 438 that have been whitelisted or blacklisted by the merchant, or a category of publishers that have been whitelisted or blacklisted) to facilitate efforts by merchants to limit distribution of their offers to publishers that are consistent with the merchant's brand.

In some embodiments, the publisher data store 438 is configured to store data about publishers that interact with the affiliate-network system 412 to distribute offers. The publisher data store 38 may include a plurality of publisher records, each publisher record corresponding to one publisher account, and in some cases, a different publisher. Each publisher record may include the following data: a publisher trade name; a publisher business-entity name; a publisher identifier that is unique to the publisher record in the affiliate-network system 412 and is used to link the publisher record to other records within the affiliate-network data store 428; a publisher category (e.g., nominal values in a taxonomy of publishers, such as those identifying sports or fashion-related publications); publisher-specific content and resources (e.g., images of the logo of the publisher at various resolutions, publisher-selected settings to configure the visual presentation of offers distributed by that publisher—such as settings defining a publisher's color scheme and indicating which colors are mapped to which offer presentation elements, like buttons, headers, and the like, a publisher's font selection, and various cascading style sheet settings defined by the publisher—as well as a publisher's contact information for consumers—like a web address of a help webpage or FAQ webpage hosted by the publisher, and various other links to other portions of the publishers website, such as a homepage of the publisher, or URIs of such publisher content or resources) to configure offer presentation from the affiliate-network system 412 in a manner that is consistent with the publisher's brand; publisher analytics tags (e.g., like those described above with respect to merchants except tied to a publisher's analytics system); publisher metrics (e.g., audience size as measured by page views, unique page views, number of publisher mobile device application installs, or audience demographics, including geographic distribution of the audience, income of the audience, education level of the audience, interests of the audience, occupations of the audience, and various other statistics characterizing the publisher's audience) to facilitate selection of publishers by merchants according to the publishers audience; distribution channels of the publisher (e.g., publisher websites, mobile device native applications, set-top box applications, and various other programs for displaying and interacting with publisher content on consumer user devices) to facilitate selections of publishers by distribution channel or selections of distribution channels by merchants; publisher geolocation capabilities (e.g., values indicating whether the publisher is capable of obtaining a user geolocation from a location sensor on a mobile phone, Internet Protocol address geolocation, or a user profile maintained with the publisher) to facilitate selection of publishers by merchants according to the expected reliability and existence of geolocation information; other consumer user device interfaces to which the publisher has access (e.g., values indicating whether the publisher operates a native application configured to access a camera of the consumer user device, a microphone of the consumer user device, a near-field communication interface of the consumer user device, a Bluetooth™ user interface of the consumer user device, or other such wireless interfaces) to facilitate selection of publishers by merchants according to these capabilities; and publisher contact information (e.g. a plurality of employee records, each having a name, password, role, phone number, email address, permissions to interact with the affiliate-network system 412, and the like of various employees of the publisher).

In some embodiments, the offer data store 440 is configured to store data about offers issued by merchants for distribution by publishers. The offer data store 440 may store a plurality of offer records, each offer record corresponding to a different offer by a merchant. In some embodiments, each offer record includes the following data: an offer identifier unique within the affiliate-network system 412 and used to link the offer record to other records in the affiliate-network data store 428; a merchant identifier indicating the merchant issuing the offer and linking to one of the merchant records in the merchant data store 436; an offer title to be included as part of offer content displayed on consumer user devices when displaying the offer; a start date of the offer indicating the date or time upon which the offer becomes valid for redemption; an expiration date indicating the date or time upon which the offer ceases to be valid and can no longer be redeemed; a publication date indicating the date or time upon which the offer is available for publishing by publishers; a publication finish date indicating the date or time upon which the offer will cease to be available for publishing; an offer type (e.g., a nominal value indicating whether the offer is a coupon, a sale, a rebate, an offer for discounted shipping, or the like) to facilitate filtering of offers by offer type by publishers or consumers; an offer tracking type (e.g., a Boolean value indicating whether the offer is being tracked, or a nominal value indicating a type of tracking); an offer monetization type (e.g., a Boolean value indicating whether the offer is being monetized (e.g., whether the merchant is compensating the operator of the affiliate-network system 412 for distributing the offer, such as a flat fee, a percent commission, or a cost-per-click reward); a commission type (e.g., a nominal value indicating whether commissions to publishers are based on a per-interaction rate, a per-redemption rate, a per-impression rate, or the like); a commission rate (e.g., a percentage or dollar amount); an offer description (e.g., a prose description of the offer to be sent to consumer user devices 420 when displaying the offer); offer rules (e.g., a condensed, consumer-friendly prose description of relatively significant terms and conditions, such as those limiting the offer to particular brands or highlighting an expiration date, for use when displaying the offer); offer terms and conditions (e.g., a relatively comprehensive prose description of terms and conditions provided by the merchant and defining the terms of the offer, which may be presented in response to a user selection of an interface in the offer content to request the terms and conditions); a store applicability type of the offer (e.g., a Boolean value indicating whether the offer is applicable across a store with no brand or category restrictions, or a nominal value indicating the absence or presence of various types of such restrictions); a domain, publisher, or publisher category whitelist or blacklist of the offer to facilitate fine-grained publisher-by-publisher distribution of subsets of offers by merchants; offer user-interaction limits (e.g., key-value pairs listing a user interaction type, such as printing, sharing in a social network, sending to a text message, or combinations of such interactions, and a limit on the number of permitted interactions for the offer, such as a limited number of times the offer may be printed, shared, sent to a text message, sent to a card-linked offer account, sent to an email account, saved to a clipboard memory of the consumer user device, or sent to an electronic wallet, or combinations thereof, including the aggregate of all interactions) to facilitate efforts by merchants to control the number of redemptions of offers; an offer redemption type (e.g., a list of nominal values indicating the channels through which the offer is redeemable, such as on mobile devices, by printing, by printing from a mobile device, across all channels, or a listing of particular mobile device applications, accepted card-linked offer account providers, electronic wallet providers, or the like that constitute a whitelist or blacklist of channels through which the offer is redeemable or not redeemable) to facilitate efforts by merchants to establish exclusive relationships with providers of such accounts and favor particular types of redemption channels through which offers are believed by merchants to be more effective; an in-store redemption indicator (e.g., a Boolean value indicating whether the offer is valid for in-store redemption by presentation of, for example, a coupon code or offer barcode, by a consumer to a clerk at a point-of-sale terminal) to again facilitate efforts by merchants to control redemption channels to those believed to be effective for the particular offer; a percentage discount of the offer (e.g., 20% off the base price of some good or service) to facilitate offer curation by publishers and consumers according to the amount of the discount and for display on the consumer user device when displaying the offer; a percentage-up-to value indicating whether some applicable discounts supported by the offer are less than the percentage off value; a minimum purchase value (e.g., a minimum purchase amount in dollars or number of goods or services required to receive the percentage off discount of the offer) for offer filtering and display; a dollar amount off from the offer (e.g., five dollars off the price of some good or service) for offer filtering and display; a dollar-up-to amount indicating whether some applicable discounts from the offer are less than the dollar amount off; a minimum-dollar-purchase amount indicating the amount required to be purchased to activate the offer's dollar amount off discount; a Boolean value indicating whether the offer includes a free gift; a prose description of a free gift item; a free shipping Boolean value indicating whether the offer is associated with free shipping of goods; a free-shipping minimum-purchase amount indicating the minimum amount that the consumer must purchase to receive free shipping; a free-gift minimum purchase indicating the minimum purchase required to receive the free gift; a buy-X-get-Y-free key-value pair indicating how many free items are offered for a number of items purchased (e.g., buy one get one free); a by-X-get-Y-free minimum purchase indicating the minimum amount to be purchased to activate the offer for buy-X-get-Y-free key-value pairs; and a category of the offer (e.g., a single-level taxonomy of offers, or a hierarchical taxonomy of offers, such as retail/sporting goods/golf equipment) to facilitate offer filtering and selection by consumers and publishers.

In some embodiments, the tracking data store 442 is configured to store data about interactions with offers, such interactions including in-store redemptions, on-line redemptions, interactions requesting that offer be sent to another consumer user device, or another consumer account (e.g., a card-linked offer account, an electronic wallet account, an email account, a social networking account, or the like). In some cases, the tracking data store 442 includes a plurality of offer-tracking records, each offer-tracking record corresponding to a different instance of interaction with an offer (e.g., a given consumer, requesting a printable view of a given offer and that consumer presenting the printout at a point-of-sale to redeem the offer would constitute two records). In some embodiments, each offer-tracking record includes the following data: an interaction identifier unique within the affiliate-network system 412 and by which offer interactions are linked with other records within the affiliate-network system 412; an identifier of an offer to which the interaction relates (e.g., an identifier of one of the offer records in the offer data store 440); a publisher identifier indicating the publisher to be credited with the interaction (e.g., an identifier of one of the publisher records in the publisher data store 438 identifying a publisher that distributed the offer to a consumer user device 420 through which the interaction occurred); related interactions (e.g., identifiers of earlier interactions potentially causally related to the interaction record, such as a print interaction that lead to an in-store redemption interaction, or a social-network sharing interaction that lead to an on-line redemption interaction by the recipient); a consumer user device identifier that identifies the consumer user device 420 upon which, or through which, the interaction occurred (e.g., a medium access control (MAC) address of the consumer user device, an advertiser identifier associated with the device, or other device identifier); an identifier of a consumer associated with the consumer user device upon which, or through which, the interaction occurred (e.g., an identifier of a user profile account having information about the user that interacted with the offer, such as name, address, offer preferences, and the like); an identifier of a session during which the interaction occurred; an identifier of an interaction-specific offer code (e.g., a single-use code dynamically generated when presenting the offer and that when presented for redemption, either in-store or on-line, identifies (e.g., uniquely) the corresponding interaction record); a publisher-specific offer code (e.g., an offer code for a given publisher that facilitated the interaction and that uniquely identifies the publisher when the offer is presented for redemption); an interaction type (e.g., a nominal value indicating on-line redemption, in-store redemption with a coupon code, in-store redemption by mobile device screen, in-store redemption by mobile device display, in-store redemption by mobile device wireless interaction with a point-of-sale terminal, in-store redemption with a printed copy of the offer, on-line or in-store redemption with a card-linked offer account, on-line or in-store redemption with an electronic wallet account, or the like); an interaction location indicating, to the extent known, a geographic location at which the interaction occurred (e.g., an identifier of a merchant's physical store, a geocoded IP address of a consumer user device used in the interaction, a location sensed by a location sensor in the consumer user device, or the like); a time of the interaction (e.g., a timestamp); a merchant associated with the interaction (e.g., a merchant through which the offer was redeemed, which in some cases may be different from the merchant that issued the offer, for example, for offers issued by brands redeemable at various retail stores); an inventory of goods or services purchased during the interaction (e.g., a plurality of transaction records listing items purchased and corresponding purchase amounts for calculating an aggregate value for the transaction upon which publishers are compensated in some cases); a transaction currency; and a consumer-user-device type of the device upon which the interaction occurred or was facilitated (e.g., an indicator of whether the consumer user device is a cell phone, tablet, personal computer, laptop, set-top box, in-dash automotive computer, a wearable computing device, or identifying a maker or software provider for the device).

Such fine-grained transaction data is expected to facilitate relatively reliable compensation of publishers by merchants, aligning the interests of the two groups, and relatively high-resolution analytics of consumer activity for improving the design of offers and publisher content. For instance, some merchants may compensate publishers for offers being printed or sent to another device even when the ultimate redemption of the offer in-store is not recorded by an interaction record. Often, when using traditional affiliate-network systems, in-store sales clerks will scan an offer barcode from a printout at their register, rather than scanning the barcode presented by the consumer, because doing so is a simpler and repetitive action, but in doing so, the publisher is potentially denied credit they might otherwise obtain from scanning a publisher-specific or single-use bar code on the printout our consumer user device display. Tracking printing and various transfers of offers between devices and accounts offers merchants a supplemental metric for determining publisher compensation and encouraging desirable publisher efforts to distribute offers.

Thus, the affiliate-network data store 428 may store values related to the provision and tracking of offers on-line and in stores. The affiliate-network data store 428 may be operative to filter, search, join, sort, augment, create, delete, modify, and search the above-mentioned records in a variety of permutations of subsets of the records. It should be noted that not all embodiments include all of the fields discussed above with reference to the affiliate-network data store 428 and that some embodiments store additional fields or use the above-mentioned fields for different purposes than are described, which is not to suggest that any other feature described herein may not also be omitted or used in a different fashion than is described.

In some embodiments, the content-negotiation module 430 is configured to dynamically format offer content according to the manner in which offers will be displayed to a consumer. In some embodiments, each offer is associated with an offer-specific URI (e.g., a uniform resource name (URN) or locater (URL)) that corresponds to multiple presentation formats of the offer appropriate for different devices or accounts. (And in some cases, the URI is both offer specific and publisher specific.) The content-negotiation module 430 may be configured to form (e.g., select among or dynamically generate) these presentation formats based on attributes of the consumer user device 420 upon which the offer will be displayed or (i.e., and/or) attributes of an account through which the offer will be conveyed to a user (e.g., an email account, a social networking account, a card-linked offer account, or an electronic wallet account).

To this end, the content-negotiation station module 430 may be configured to receive data about the type of presentation (e.g., device attributes or account attributes) with a variety of different techniques. In some cases, a request from a consumer user device 420 to the affiliate-network system 412 for offer content corresponding to a URI includes user agent information about the consumer user device 420, such as a user agent string in a header of a request specified by a transport protocol (e.g., HTTP or SPDY). In some cases, the user agent information may be included with a get request under the transport protocol for resources at the URI. User agent information may include an identifier of a web browser, an operating system, a listing of accepted media types, supported character sets, encodings, languages, and the like. In some cases, the request for content at the offer URI includes information about the manner in which the offer will be displayed, for example, a screen size expressed in resolution or absolute geometric dimensions, a window size expressed in pixels or geometric dimensions, color capabilities, three-dimensional capabilities, and the like. In some cases, the request indicates whether the offer will be displayed on a printout from a printer, or whether the offer will be displayed in a particular type of account, such as those listed above.

In some cases, the request is not a sufficiently-specified description of how the offer will be displayed, and the content-negotiation module 30 may send instructions to the requesting consumer user device 420 to further identify such attributes, such as JavaScript™ that when executed returns a window size, a screen resolution, and i-frame size, a div-box size, a document-object-model (DOM) element size, or the like, within which the responsive offer content will be displayed. The code, when executed in a web-browser of a consumer user device 420, may return the corresponding parameters to the content negotiation module 430. In some cases, the request is from a native application executing on a consumer user device 420, and the request is received via the API server 424. An API of the affiliate-network system 412 may specify that requests include the above-mentioned information about the consumer user device 420 or account, or embodiments may send a default format of offer content when such information is unavailable.

In some embodiments, the content-negotiation module 30 is configured to retrieve the appropriate offer content for the URI (e.g., offer resources, like prose descriptions and images, and instructions for displaying the resources and, in some cases, for providing offer-selection interfaces for a given offer) based on the data indicating how the offer will be displayed. For example, the content-negotiation module 430 may receive data indicating that the offer will be displayed on a mobile phone, tablet, laptop, or desktop computer in a web browser, email account, text message, social networking account, card-linked offer account, electronic wallet account, or the like. In response, the module 430 may form (e.g., select or generate) an offer presentation template corresponding to one of these types of presentation. Thus, some embodiments of the content-negotiation module 430 may store in memory a plurality of different offer presentation templates, each template corresponding to a different type of consumer user device, presentation environment on a consumer user device, or account through which the offer will be presented to a user. Or in some cases, some or all of the offer templates are dynamically generated according to the type of presentation, for example, dynamically scaling dimensions, image resolutions, and font sizes with the size of the display of the consumer user device 420 or size of a window or DOM element in which the offer content will be shown.

An offer template, in some cases, specifies text to be included in offer content, for example, specifying the inclusion of more expansive prose descriptions of offers in templates for larger display screens or accounts in which longer bodies of text are appropriate (like in email, as opposed to text messages). In some cases, shorter and longer version of offer descriptions are maintained in the offer records for this purpose. Similarly, offer templates may specify larger fonts, higher-resolution images, and more images, in templates for larger display screens or for accounts configured to accommodate richer content. Thus, the offer templates may include instructions to retrieve and display various offer-related resources, such as a merchant logo, an offer-specific image, a prose description of the offer, and a description of various terms and conditions of the offer. In some cases, various versions of the offer content are maintained in the offer data store 440, such as lower and higher resolution versions of images, and more concise and less concise versions of text, and the offer templates may specify these different versions depending upon the type of presentation to the consumer.

Offer template selection may also depend upon the potential use of a consumer user device 420 for in-store redemptions (e.g., templates may differ for mobile phones and desktop computers to account for the potential presentation of the mobile device in-store). In some implementation, templates for printing offers (e.g., those that provide printable views of offers in black-and-white and are sized for A4 paper) may include a barcode image (or QR code, or the like) that can be scanned at a point-of-sale terminal for redeeming an offer. Templates for use on mobile user devices may include such images as well (e.g., by specifying that when the template is populated for a given offer, a barcode image for that offer is generated or retrieved and added to offer content formed based on the template). Images for optically-machine-readable codes, like barcodes and QR codes, may be included in (e.g., linked to with a URI) the above-mentioned offer records. Or some embodiments may generate publisher-specific, user-specific, or session-specific optically-machine-readable codes that uniquely identify one of these items. The code may be associated with a publisher record, a user profile, or an interaction record, depending on the application, and after the code is scanned at a point-of-sale terminal, the respective item (e.g., publisher record, user profile, or interaction record) may be associated with the transaction at the point-of-sale terminal to track publisher, user, and offer metrics.

In some cases, the offer templates include (e.g., specify, in part, how to form) interfaces by which a user further interacts with offers. Examples of such interfaces include on-screen buttons that, when selected (e.g., by touching or clicking), launch a client-side script or routine that issues a request from the consumer user device to the affiliate-network system 412 for a different presentation of the offer, such as a printable view. With a similar process, other included interfaces (e.g., buttons, voice commands, or gestures) may indicate that the offer should be sent to another consumer user device 420 or account, such as a button to launch an interface for entering a phone number to which offer content is texted or an email account to which an email version of offer content is sent. In some cases, the set of interfaces are different for the different templates.

In some cases, the offer templates include publisher-specific attributes of offer content that are formed (e.g., selected or generated) based on the identity of the publisher that advanced the URI to a consumer user device 420 (which then requests corresponding offer content from the affiliate-network system 412). To this end, in some embodiments, the content-negotiation module 430 may parse from the request for offer content an identifier of a publisher, and the module 430 may retrieve information for populating the template based on publisher-specific content, such as images and other attributes like colors, fonts, links, and text. For example, offer content may include one or more on-screen buttons, and an offer template may specify a publisher-button-color field for determining the button color. In response, when populating this template for a URI advanced by a given publisher, the content-negotiation module 430 may retrieve from the publisher data store 438 that publisher's selection of a color of the button and form offer content in accordance with the selection. Similar fields may specify other aspects of offer content. Thus, in some embodiments, different publishers may direct consumers to the same offer with different colors, publisher logos, publisher's terms of use, links to other publisher content, links to publisher help webpages, and the like.

In short, the content-negotiation module 430 customizes offer content based on context. In some embodiments, the visual depiction of an offer may depend on the attributes of the consumer user device 420 upon which the offer will be displayed, the type of account through which the offer is presented, and the publisher from which the consumer user device 420 received the URI of the offer. The content-negotiation module 430 may populate the templates based on responsive resources and send instructions to the consumer user device 420 to display the offer content.

In some embodiments, the affiliate-network system 412 includes a dynamic-terms offer controller 432 that dynamically adjusts the terms of offers (e.g., types of redemption, expiration date, start date, percent discount, and the like) based on feedback from the tracking data store 442, which may indicate both an amount of on-line redemption activity and off-line (such as in-store) redemption activity. The affiliate-network system 412, as noted above, tracks offer interactions across multiple channels. A benefit of this approach is that offers can be dynamically controlled relatively reliability based on relatively comprehensive accounting of offer usage or likely usage. (Though, not all embodiments necessarily provide these benefits.) For instance, a merchant may specify that the percent discount of an offer is to decrease by some amount (or the offer is to expire) automatically in response to the aggregate of on-line and off-line interactions exceeding a threshold rate or amount, thereby constraining offers that have spread more widely than anticipated or potentially specify a greater discount than the merchant intended to offer due to a data entry error. In some cases, these thresholds are set automatically, for instance at five standard deviations of an aggregate rate (e.g., a daily average) of accumulation of offer interaction records for offers for a given merchant, and alerts are issued to the merchant in response to the threshold being exceeded so that the merchant can manually intervene and terminate or adjust an offer if needed.

In some embodiments, the affiliate-network system 412 further includes the analytics module 434, which may be configured to query data from the tracking data store 442 and present role-specific reports to publishers, merchants, and administrators of the affiliate-network system 412. The analytics module 434 may be operative to receive a request for such a report specifying various criteria, such as a merchant account or a publisher account, query the tracking data store 442 for the responsive data, and generate visual depictions of the data, such as those described below. Reports that account for both on-line and off-line interactions with offers are expected to simplify the process of monitoring and analyzing offers that are redeemable through multiple channels, an undertaking which can be relatively arduous with traditional affiliate-network systems, particularly for merchants issuing hundreds of new offers each day. (Though, again, not all embodiments necessarily provide this benefit.)

Some embodiments of the affiliate-network system 412 implement techniques to protect user privacy, for example, anonymizing identifiers of consumer user devices 420 by hashing information from the consumer user devices 420, reducing the granularity of attributes recorded in association with user interactions (like rounding less significant digits of latitude and longitude coordinates), and providing privacy-controls by which consumers or publishers can implement user privacy-preferences.

In summary, the affiliate-network system 412, in some embodiments, is operative to coordinate activities relating to offers by web-scale numbers of consumer user devices 420, merchant systems 416, and publishers 418, which may implicate potentially hundreds of thousands or millions of offers, some of which may be dynamically adjusted with terms that change over time, some of which may have visual depictions that are dynamically adjusted, and some of which may have single-use offer tracking codes corresponding to an individual consumer interactions with offers. To accommodate operations at these scales, in some cases, the affiliate-network system 412 may include a relatively large number of geographically distributed networked computing devices and employ various techniques to speed operation, such as use of elastic scaling of the system 412 and use of content-delivery networks.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Statements about “each” of some item having an attribute or undergoing an operation should not be read as limiting the description to systems in which each and every instance of an item have the attribute or undergo the operation, i.e., “each” includes each of at least some, and does not require “each and every.” Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method of dynamically adjusting an online coupon, or other offer, redemption work flow presented to a consumer to mitigate effects from more limited user-interface constraints of mobile computing devices relative to desktop computing devices, the method comprising: obtaining for a plurality of merchant websites a plurality of mobile-suitability values, each mobile-suitability value being indicative of suitability of a respective one of the plurality of merchant websites for use on mobile computing devices; receiving, over a network, from a remote mobile computing device of a user, a request for offer content that causes the mobile computing device to display an offer; ascertaining a selected merchant website, among the plurality of merchant websites, at which the offer is redeemable; retrieving, from the plurality of mobile-suitability values, a selected mobile-suitability value for the selected merchant website; obtaining, from the mobile computing device, data indicative of user-interface constraints of the mobile computing device; determining to send instructions to present content on the mobile computing device, the determination being based on the user-interface constraints of the mobile computing device and the selected mobile-suitability value for the selected merchant website, and the content being suitable for the mobile computing device; and sending the instructions to present the content to the mobile computing device.
1.5. The method of embodiment 1, wherein the instructions to present content include instructions to present a platform-shift user-interface on the mobile computing device, wherein the platform-shift user-interface includes a user-selectable input that facilitates redemption of the offer on a different computing device from the mobile computing device or redemption of the offer with a different platform from the selected merchant website.
2. The method of embodiment 1, wherein obtaining for the plurality of merchant websites the plurality of mobile-suitability values comprises: empirically calculating the mobile-suitability values based on historical conversion rates of the respective merchant websites.
3. The method of embodiment 2, wherein empirically calculating the mobile-suitability values based on historical conversion rate of the respective merchant websites comprises: obtaining a category of a given merchant website; and comparing the historical conversion rate of the given merchant website to historical conversion rates of other merchant websites in the same category.
4. The method of any of embodiments 2-3, wherein empirically calculating the mobile-suitability values based on historical conversion rates of the respective merchant websites comprises: obtaining data describing a plurality of instances in which an offer redeemable on a given merchant website was presented and whether the offer was redeemed in each instance, and determining which of the instances are unique by consolidating instances occurring within a threshold duration.
5. The method of any of embodiments 2-4, comprising calculating the historical conversion rate by weighting instances in which an offer redeemable on a given merchant website was presented differently based on an amount of time elapsed since the instance.
6. The method of any of embodiments 2-5, wherein empirically calculating the mobile-suitability values based on historical conversion rates of the respective merchant websites comprises: for each of the plurality of merchant websites, empirically calculating a plurality of device-category-specific mobile-suitability values based on historical conversion rates of user devices in respective categories of mobile computing devices for the respective merchant websites, and wherein retrieving, from the plurality of mobile-suitability values, the selected mobile-suitability value for the selected merchant website comprises: selecting a category of mobile computing device of which the mobile computing device of the user is a member; and selecting a corresponding device-category-specific mobile-suitability value based on historical conversion rates.
7. The method of any of embodiments 1-6, wherein obtaining for the plurality of merchant websites the plurality of mobile-suitability values comprises: receiving mobile-suitability values for a given merchant website from a plurality of reviewers, different ones of the plurality of viewers viewing the given merchant website on different mobile devices having different user-interface constraints; and calculating a measure of central tendency of the received mobile-suitability values for the given merchant website.
8. The method of embodiment 7, comprising: storing in memory data indicative of a previous version of the given-merchant website; obtaining a current version of the given merchant website; determining that the given merchant website has changed by comparing the current version website to the data indicative of the previous version of the given merchant website; and in response to the determination that the given merchant website has changed, sending instructions to reviewers to perform a second review of the given merchant website.
9. The method of any of embodiments 1-8, comprising: requesting a given merchant website with an automated web browser by sending with the request for the given merchant website a first user agent string; receiving a first instance of the given merchant website; requesting the given merchant website with an automated web browser, the same or different from the aforementioned automated web browser, by sending with the request for the given merchant website a second user agent string, the second user agent string being different from the first user agent string; receiving a second instance of the given merchant website; and comparing the first instance of the given merchant website and the second instance of the given merchant website; and determining a mobile-suitability value for the given merchant website based on the comparison.
10. The method of any of embodiments 1-9, comprising: request a given merchant website; receiving the given merchant website; rendering the given merchant website; and determining a mobile-suitability value based on a size of a button in the rendering merchant website.
11. The method of any of embodiments 1-10, wherein obtaining from the mobile computing device data indicative of the user-interface constraints of the mobile computing device comprises: receiving a user agent string accompanying a hyper-text transport protocol request, wherein the user agent string identifies a web browser, a version of the web browser, and a type of computing device.
12. The method of any of embodiments 1-11, wherein obtaining from the mobile computing device data indicative of the user-interface constraints of the mobile computing device comprises: sending the mobile computing device JavaScript instructions to retrieve a screen dimension from a window object of a web browser executing on the mobile computing device and return the screen dimension of the window object; and receiving the screen dimension.
13. The method of any of embodiments 1-12, wherein: the selected mobile-suitability value for the selected merchant website comprises a first suitability value indicative of suitability for a given screen dimension and a second suitability value indicative of user interface events used by the selected merchant website; the data indicative of the user-interface constraints of the mobile computing device comprises a first constraint value indicative of a screen dimension of the mobile computing device and a second constraint value indicative of user interface events supported by a web browser executing on the mobile computing device.
14. The method of any of embodiments 1-13, wherein: the instructions to present the platform-shift user-interface cause the mobile computing device to present the user with an input that, when selected by the user, causes an email describing the offer to be sent to an email account.
15. The method of any of embodiments 1-14, wherein: the instructions to present the platform-shift user-interface cause the mobile computing device to present the user with an input that, when selected by the user, causes a short-message-service text message describing the offer to be sent.
16. The method of any of embodiments 1-15, wherein: the instructions to present the platform-shift user-interface cause the mobile computing device to present the user with an input that, when selected by the user, causes a record of the offer to be added to an account of the user.
17. The method of embodiment 16, wherein the account is a card-linked offer account.
18. The method of embodiment 16, wherein the account includes a list of favorite offers identified by the user in a user account of the user in an offer-aggregation system.
19. The method of embodiment 1, wherein: obtaining for the plurality of merchant websites the plurality of mobile-suitability values comprises: evaluating the plurality of merchant websites for suitability for display on mobile computing devices based on: comparisons of age-weighted historical conversion rates on the respective merchant websites relative to merchant websites in the same category of merchants and relative to historical conversion rates on non-mobile user devices; requesting, receiving, rendering, and comparing sizes of user interface elements of the respective merchant websites to screen sizes of mobile computing devices; storing, for each of the plurality of merchant websites, a plurality of values indicative of the comparisons relative to age-weighted historical conversion rates and sizes of user interface elements; receiving, over the network, from the mobile computing device of the user, the request for the offer content that causes the mobile computing device to display the offer comprises: receiving, with an offer-aggregation system, via the Internet, a request for a web page describing the offer, wherein the offer-aggregation system stores a plurality of offers from a plurality of merchants and is configured to identify offers for users in response to queries for offers from web browsers and native mobile applications sending application program requests to the offer-aggregation system for offers; ascertaining the selected merchant website, among the plurality of merchant websites, at which the offer is redeemable comprises: selecting a subset of offers among the plurality of offers based on criteria specified in the request for the offer content; ranking the subset of offers based on the mobile-suitability values; and selecting an offer based on the ranking and identifying a merchant at which the selected offer is redeemable; obtaining from the mobile computing device data indicative of the user-interface constraints of the mobile computing device comprises: receiving a user agent string accompanying a hyper-text transport protocol request, wherein the user agent string identifies a web browser, a version of the web browser, and a type of computing device; sending the mobile computing device JavaScript instructions to retrieve a screen dimension from a window object of a web browser executing on the mobile computing device and return the screen dimension of the window object; and receiving the screen dimension; determining to send instructions to present a platform-shift user-interface to the mobile computing device comprises: comparing the screen dimension and data from the user agent string to the selected mobile-suitability value to estimate a likelihood of the user redeeming the selected offer; and determining that the estimated likelihood exceeds a threshold; sending the instructions to present the platform-shift user-interface to the mobile computing device comprises: sending instructions that cause the mobile computing device to present the user with a plurality of inputs that, when a respective input is selected by the user, cause: a record of the offer to be added to an account of the user; a short-message-service text message describing the offer to be sent; and an email describing the offer to be sent to an email account, depending on which of the plurality of inputs is selected.
20. The method of any of embodiments 1-19, wherein the offer is an online coupon.
21. The method of any of embodiments 1-20, further including a method of inferring a user's intent when searching for coupons and other offers, the method comprising: obtaining a purchase-intent model, the purchase-intent model being configured to calculate a purchase-intent score based on a geolocation of a user, a time during which the user requests offer content, a product category for which the user requests offer content, or a search history of the user requesting offer content, wherein the purchase-intent score estimates the likelihood that a user is shopping with intent to purchase rather than with intent to browse; receiving, via a network, a request for offer content from a computing device of a user; calculating, with one or more processors, a purchase-intent score with the purchase-intent model based on the request for offer content; determining that the purchase-intent score satisfies a threshold; selecting offer content based on the determination that the purchase-intent score satisfies the threshold; and sending the offer content to the computing device of the user.
22. The method of embodiment 21, wherein the purchase-intent model is configured to calculate the purchase-intent score based on the geolocation of the user, the time during which the user requests offer content, the product category for which the user requests offer content, and the search history of the user requesting offer content.
23. The method of embodiment 21, wherein the purchase-intent model is configured to calculate the purchase intent score based on a weighted sum of sub-scores for two or more of the geolocation of the user, the time during which the user requests offer content, the product category for which the user requests offer content, and the search history of the user requesting offer content.
24. The method of embodiment 23, comprising: testing different weights for the weighted sum; determining that the different weights result in higher conversion rates than a current weighting; and changing the current weighting in response to determining that the different weights result in higher conversion rates than the current weighting.
25. The method of any of embodiments 21-24, wherein the purchase-intent score is based on the geolocation of a user and a geolocation of a retail store at which offers are redeemable.
26. The method of embodiment 25, wherein the purchase-intent score is based on a determination that the geolocation of the user is within a geofence associated with one or more retail stores.
27. The method of any of embodiments 21-26, wherein the purchase-intent score is based on a time of day during which the user requests offer content.
28. The method of embodiment 27, wherein the purchase-intent score is based on a determination that the user is requesting offer content during the evening in the geolocation from which the user requests offer content.
29. The method of any of embodiments 21-28, wherein the purchase-intent score is based on a day of the week or season of the year during which the user requests offer content.
30. The method of any of embodiments 21-29, wherein: the purchase-intent model comprises a data structure associating product categories with purchase-intent sub-scores; and calculating the purchase-intent score comprises: ascertaining a product category to which the request for offer content pertains; and retrieving a purchase-intent sub-score from the data structure based on the product category.
31. The method of any of embodiments 21-30, wherein the purchase-intent score is based on a determination that the search history of the user requesting offer content contains requests for offer content from more than a threshold amount of merchants within a duration of time.
32. The method of embodiment 31, wherein the requests for offer content for offers from more than a threshold amount of merchants within a duration of time are requests for offer content for offers from merchants within single category of merchants.
33. The method of any of embodiments 21-32, wherein the purchase-intent score is based on a determination that the user has requested an offer for a particular merchant.
34. The method of any of embodiments 21-33, wherein determining that the purchase-intent score satisfies a threshold comprises inferring that the user is browsing.
35. The method of embodiment 34, wherein selecting offer content based on the determination that the purchase-intent score satisfies the threshold comprises: selecting offers from a plurality of merchants within a category of merchants to which the request for offer content pertains.
36. The method of embodiment 34, wherein selecting offer content based on the determination that the purchase-intent score satisfies the threshold comprises: selecting offers pertaining to a plurality of products in a product category to which the request for offer content pertains.
37. The method of any of embodiments 21-33, wherein determining that the purchase-intent score satisfies a threshold comprises inferring that the user is viewing offers with the intent to purchase goods or services.
38. The method of embodiment 37, comprising: determining that the computing device of the user is a mobile computing device; determining that a website of a merchant at which an offer of the requested offer content is redeemable is not suitable for the mobile computing device; and in response to determining that the website of the merchant is not suitable, sending the computing device of the user a platform-shift user-interface, wherein the platform-shift user-interface includes a user-selectable input that facilitates redemption of an offer on a different computing device from the mobile computing device or redemption of the offer with a different platform from the selected merchant website.
39. The method of embodiment 37, wherein: obtaining the purchase-intent model comprises: assigning weights to values indicative of geolocation, time during which offer content is requested, product category, and the search history based on conversion rates documented in historical offer logs; sending the offer content to the computing device of the user comprises: sending the computing device of the user instructions to present a web page for redeeming an offer of the offer content, the web page including a description of the offer, a coupon code, and hyperlinks to an affiliate network that redirect the web browser to a website of a merchant issuing the responsive offer.
40. A tangible, non-transitory, machine-readable medium storing instructions that when executed by a data processing apparatus cause the data processing apparatus to perform operations comprising: the steps of any of embodiments 1-39.
41. A system, comprising: one or more processors; and memory storing instructions that when executed by the processors cause the processors to effectuate operations comprising: the steps of any of embodiments 1-39.

What is claimed is:

1. A method of dynamically adjusting an online coupon, or other offer, redemption work flow presented to a consumer to mitigate effects from more limited user-interface constraints of mobile computing devices relative to desktop computing devices, the method comprising:
obtaining for a plurality of merchant websites a plurality of mobile-suitability values, each mobile-suitability value being indicative of suitability of a respective one of the plurality of merchant websites for use on mobile computing devices;
receiving, over a network, from a remote mobile computing device of a user, a request for offer content that causes the mobile computing device to display an offer;
ascertaining a selected merchant website, among the plurality of merchant websites, at which the offer is redeemable;
retrieving, from the plurality of mobile-suitability values, a selected mobile-suitability value for the selected merchant website;
obtaining, from the mobile computing device, data indicative of user-interface constraints of the mobile computing device;
determining to send instructions to present content on the mobile computing device, the determination being based on the user-interface constraints of the mobile computing device and the selected mobile-suitability value for the selected merchant website, and the content being suitable for the mobile computing device; and
sending the instructions to present the content to the mobile computing device.

2. The method of claim 1, wherein obtaining for the plurality of merchant websites the plurality of mobile-suitability values comprises:
empirically calculating the mobile-suitability values based on historical conversion rates of the respective merchant websites.

3. The method of claim 2, wherein empirically calculating the mobile-suitability values based on historical conversion rate of the respective merchant websites comprises:
obtaining a category of a given merchant website; and
comparing the historical conversion rate of the given merchant website to historical conversion rates of other merchant websites in the same category.

4. The method of claim 2, wherein empirically calculating the mobile-suitability values based on historical conversion rates of the respective merchant websites comprises:
obtaining data describing a plurality of instances in which an offer redeemable on a given merchant website was presented and whether the offer was redeemed in each instance, and
determining which of the instances are unique by consolidating instances occurring within a threshold duration.

5. The method of claim 2, comprising calculating the historical conversion rate by weighting instances in which an offer redeemable on a given merchant website was presented differently based on an amount of time elapsed since the instance.

6. The method of claim 2, wherein empirically calculating the mobile-suitability values based on historical conversion rates of the respective merchant websites comprises:
for each of the plurality of merchant websites, empirically calculating a plurality of device-category-specific mobile-suitability values based on historical conversion rates of user devices in respective categories of mobile computing devices for the respective merchant websites, and
wherein retrieving, from the plurality of mobile-suitability values, the selected mobile-suitability value for the selected merchant website comprises:
selecting a category of mobile computing device of which the mobile computing device of the user is a member; and
selecting a corresponding device-category-specific mobile-suitability value based on historical conversion rates.

7. The method of claim 1, wherein obtaining for the plurality of merchant websites the plurality of mobile-suitability values comprises:
receiving mobile-suitability values for a given merchant website from a plurality of reviewers, different ones of the plurality of viewers viewing the given merchant website on different mobile devices having different user-interface constraints; and
calculating a measure of central tendency of the received mobile-suitability values for the given merchant website.

8. The method of claim 7, comprising:
storing in memory data indicative of a previous version of the given-merchant website;
obtaining a current version of the given merchant website;
determining that the given merchant website has changed by comparing the current version website to the data indicative of the previous version of the given merchant website; and
in response to the determination that the given merchant website has changed, sending instructions to reviewers to perform a second review of the given merchant website.

9. The method of claim 1, comprising:
requesting a given merchant website with an automated web browser by sending with the request for the given merchant website a first user agent string;
receiving a first instance of the given merchant website;
requesting the given merchant website with an automated web browser, the same or different from the aforementioned automated web browser, by sending with the request for the given merchant website a second user agent string, the second user agent string being different from the first user agent string;
receiving a second instance of the given merchant website; and
comparing the first instance of the given merchant website and the second instance of the given merchant website; and
determining a mobile-suitability value for the given merchant website based on the comparison.

10. The method of claim 1, comprising:
request a given merchant website;
receiving the given merchant website;
rendering the given merchant website; and
determining a mobile-suitability value based on a size of a button in the rendering merchant website.

11. The method of claim 1, wherein obtaining from the mobile computing device data indicative of the user-interface constraints of the mobile computing device comprises:
receiving a user agent string accompanying a hyper-text transport protocol request, wherein the user agent string identifies a web browser, a version of the web browser, and a type of computing device.

12. The method of claim 1, wherein obtaining from the mobile computing device data indicative of the user-interface constraints of the mobile computing device comprises:
sending the mobile computing device JavaScript instructions to retrieve a screen dimension from a window object of a web browser executing on the mobile computing device and return the screen dimension of the window object; and
receiving the screen dimension.

13. The method of claim 1, wherein:
the selected mobile-suitability value for the selected merchant website comprises a first suitability value indicative of suitability for a given screen dimension and a second suitability value indicative of user interface events used by the selected merchant website;
the data indicative of the user-interface constraints of the mobile computing device comprises a first constraint value indicative of a screen dimension of the mobile computing device and a second constraint value indicative of user interface events supported by a web browser executing on the mobile computing device.

14. The method of claim 1, wherein the instructions to present content include instructions to present a platform-shift user-interface on the mobile computing device, wherein the platform-shift user-interface includes a user-selectable input that facilitates redemption of the offer on a different computing device from the mobile computing device or redemption of the offer with a different platform from the selected merchant website.

15. The method of claim 14, wherein:
the instructions to present the platform-shift user-interface cause the mobile computing device to present the user with an input that, when selected by the user, causes an email describing the offer to be sent to an email account.

16. The method of claim 14, wherein:
the instructions to present the platform-shift user-interface cause the mobile computing device to present the user with an input that, when selected by the user, causes a short-message-service text message describing the offer to be sent.

17. The method of claim 14, wherein:
the instructions to present the platform-shift user-interface cause the mobile computing device to present the user with an input that, when selected by the user, causes a record of the offer to be added to an account of the user.

18. The method of claim 17, wherein the account is a card-linked offer account.

18. The method of claim 17, wherein the account includes a list of favorite offers identified by the user in a user account of the user in an offer-aggregation system.

20. The method of claim 14, wherein:
obtaining for the plurality of merchant websites the plurality of mobile-suitability values comprises:
evaluating the plurality of merchant websites for suitability for display on mobile computing devices based on:
comparisons of age-weighted historical conversion rates on the respective merchant websites relative to merchant websites in the same category of merchants and relative to historical conversion rates on non-mobile user devices;
requesting, receiving, rendering, and comparing sizes of user interface elements of the respective merchant websites to screen sizes of mobile computing devices;
storing, for each of the plurality of merchant websites, a plurality of values indicative of the comparisons relative to age-weighted historical conversion rates and sizes of user interface elements;
receiving, over the network, from the mobile computing device of the user, the request for the offer content that causes the mobile computing device to display the offer comprises:
receiving, with an offer-aggregation system, via the Internet, a request for a web page describing the offer, wherein the offer-aggregation system stores a plurality of offers from a plurality of merchants and is configured to identify offers for users in response to queries for offers from web browsers and native mobile applications sending application program requests to the offer-aggregation system for offers;
ascertaining the selected merchant website, among the plurality of merchant websites, at which the offer is redeemable comprises:
selecting a subset of offers among the plurality of offers based on criteria specified in the request for the offer content;
ranking the subset of offers based on the mobile-suitability values; and
selecting an offer based on the ranking and identifying a merchant at which the selected offer is redeemable;
obtaining from the mobile computing device data indicative of the user-interface constraints of the mobile computing device comprises:
receiving a user agent string accompanying a hyper-text transport protocol request, wherein the user agent string identifies a web browser, a version of the web browser, and a type of computing device;
sending the mobile computing device JavaScript instructions to retrieve a screen dimension from a window object of a web browser executing on the mobile computing device and return the screen dimension of the window object; and
receiving the screen dimension;
determining to send instructions to present a platform-shift user-interface to the mobile computing device comprises:
comparing the screen dimension and data from the user agent string to the selected mobile-suitability value to estimate a likelihood of the user redeeming the selected offer; and
determining that the estimated likelihood exceeds a threshold;
sending the instructions to present the platform-shift user-interface to the mobile computing device comprises:
sending instructions that cause the mobile computing device to present the user with a plurality of inputs that, when a respective input is selected by the user, cause:
a record of the offer to be added to an account of the user;
a short-message-service text message describing the offer to be sent; and
an email describing the offer to be sent to an email account, depending on which of the plurality of inputs is selected.

21. A system, comprising:
one or more processors; and
memory storing instructions that when executed by at least some of the one or more processors causes operations comprising:
obtaining for a plurality of merchant websites a plurality of mobile-suitability values, each mobile-suitability value being indicative of suitability of a respective one of the plurality of merchant websites for use on mobile computing devices;
receiving, over a network, from a remote mobile computing device of a user, a request for offer content that causes the mobile computing device to display an offer;
ascertaining a selected merchant website, among the plurality of merchant websites, at which the offer is redeemable;
retrieving, from the plurality of mobile-suitability values, a selected mobile-suitability value for the selected merchant website;
obtaining, from the mobile computing device, data indicative of user-interface constraints of the mobile computing device;
determining to send instructions to present a platform-shift user-interface to the mobile computing device, the determination being based on the user-interface constraints of the mobile computing device and the selected mobile-suitability value for the selected merchant website,
determining to send instructions to present content on the mobile computing device, the determination being based on the user-interface constraints of the mobile computing device and the selected mobile-suitability value for the selected merchant website, and the content being suitable for the mobile computing device; and
sending the instructions to present the content to the mobile computing device
